(19) United States
(12) Patent Application Publication
(10) Pub. No.: US 2013/0119614 A1
(43) Pub. Date: May 16, 2013

(54) COMPENSATING AND SEALING RINGS FOR PISTONS OF ENGINES, COMPRESSORS, EXHAUSTERS AND PUMPS

(71) Applicant: Jairo Antunes De Oliveira, Londrina (BR)

(72) Inventor: Jairo Antunes De Oliveira, Londrina (BR)

(21) Appl. No.: 13/466,548

(22) Filed: May 8, 2012

(30) Foreign Application Priority Data
Nov. 23, 2009 (BR) 015090003432
Nov. 23, 2009 (BR) PI0906127
Nov. 19, 2010 (BR) PCT/BR2010/000387

(51) Int. Cl. F02F 5/00

(52) U.S. Cl. CPC F02F 5/00; F16J 15/00
USPC 277/434

(57) ABSTRACT

COMPENSATIVE AND SEALING RINGS FOR PISTONS OF ENGINES, COMPRESSORS, EXHAUSTERS AND PUMPS, invention patent for piston rings according to the title, being the compensative subdivided in models AC1 (picture 1), AC2 (picture 6), AC3 (picture 12) and AC4 (picture 15), characterized by indents and saliencies or bosses that fit on their ends (pictures 1 and 6) and overlays (composed rings as seen in pictures 1, 6, 12 and 15), and the Sealing Rings subdivided in models AVCE1 (picture 20), AVCE2 (picture 27), AVCE3 (picture 33), AVCE4 (picture 40), AVCE5 (picture 45) and AVCE6 (picture 53), characterized by fitting in built-in grooves unified to the conventional, thus sealing the oil and gases escape. They are endowed with self-propulsive force or are impelled or driven by the propelling spring ring.

This patent of invention refers to several ring models, used in a variety of purposes as the title says, seeking a better performance than the previous existing models, wherever they are used.

The currently used rings are already well known of those involved in mechanics, and have three basic functions: oil rings, scraper rings and compression rings. The system's current state of the art presents two inconvenient points: first is the well known wear between rings and the cylinder bore, natural from friction among both, causing an aperture or continuously opening gap among ring tips; second is the lateral wear that happens between the ring and the piston groove. These two factors are held responsible for a phenomenon known as blow by—gas leak to the engine's interior and oil leak into the explosion chamber, two extremely undesirable side effects.

Those wastages lead to several issues, such as progressive oil burn, considerable gas leak to the engine's interior (blow by), consequent engine's oil contamination by explosion particles, premature engine wastage, power loss and environment pollution—by far the worst.

Aiming to minimize the two inconvenient points mentioned above, the applicant has invented the sealing and compensative rings, seeking to remedy the problems and extend the engine's life.

### “The Compensative Rings”

PI 0906127-4 from Nov, 23^{rd}, 2009 and C1 0906127-4 from Jul. 8^{th}, 2010 PCT/BR2010/000387 published May 26^{th}, 2011 under No. WO 2011/060521

Regarding the first inconvenient factor, which is the growing distance between ring tips, and in order to overcome it, were developed this compensative rings models (AC), in different shapes and projected in such a way that even if the wear between parts remains, through a self-adjustment, sealing the gas, oil and waste passage, providing the engine a great endurance quality and reducing environment pollution. They will be presented in four (4) different models, always depicted in this descriptive memorandum by the abbreviations AC1, AC2, AC3, and AC4.

### The Sealing Rings

PI 015090003432 from Nov. 23^{rd}, 2009 PCT/BR2010/000387 published May 26^{th}, 2011 under No. WO 2011/060521

In order to minimize the second inconvenient point, the applicant developed the Sealing Rings in Conduits Embedded to the Conventional (AVCE), which will be presented here in 6 different models. In the exposure of this descriptive report, such rings will be depicted by the abbreviations ACVE1, ACVE2, ACVE3, ACVE4, ACVE5 and ACVE6.

The AVCE's mentioned above were projected in order to work placed in conduits, or grooves, embedded to the conventional conduit, whether it's the compression ring, scrapper ring or oil ring. They might work unified to the upper or to the inferior part, or even to both locations. There are different shapes among them, with 5 presenting expansive action and 1 with constrictive action, but all with propulsive effect that leads them permanently towards the conventional ring, thus sealing gas leak (blow-by) as well as oil leak to the combustion chamber.

### Compensative Rings Pictures Exposure

In picture 01 the AC1, composed, named “External Embedded”.

In picture 02 the AC1 in exploded vision.

In picture 03 the AC1 in its inferior component.

In picture 04 the AC1 in its upper component.

In picture 05 the AC1 in one piece, with the two parts embedded.

In picture 06 the AC2, also called “Internal Embedded”.

In picture 07 the AC2 in exploded vision.

In picture 08 the AC2 also in exploded vision.

In picture 09 the AC2 in its upper part, focusing the bounce.

In picture 10 the AC2 in its inferior part, where it is possible to see the recess fitting.

In picture 11 the AC3 composed.

In picture 12 the AC3 model in exploded vision.

In picture 13 one of the AC3 model components.

In picture 14 the AC4 composed.

In picture 15 the AC4 model in exploded vision.

In pictures 16 and 17, components apart from AC4, detailing the relegation.

In pictures 18 and 19 also AC4 components, detailing grooves in the ring's external face.

### Picture Exposure Concearning the Sealing Rings

Concerning to the AVCE1

In picture 20—The first AVCE1 element, the sealing ring.

In picture 21—The same sealing element seeing by another perspective.

In picture 22—The second AVCE1 element, its built-in groove twinned to the conventional groove.

In picture 23—The AVCE1 placed in its groove, pressed by the conventional ring.

In picture 24—The AVCE1 in double position, inferior and upper, pressing the conventional ring with the piston in rising movement.

In picture 25—The AVCE1 in double position, inferior and upper, with the conventional ring on its intermediate state.

In picture 26—The great cavity holding two AVCE1 built-in grooves plus the conventional ring's groove.

Concerning to the AVCE2

In picture 27—The first AVCE2 element, the sealing ring.

In picture 28—The second AVCE2 element, the built-in groove twinned to the conventional.

In picture 29—The AVCE2 placed in the inferior side of the conventional ring.

In picture 30—The great cavity where can be found the built-in groove's room, inferior and upper, and at the center the conventional room.

In picture 31—The AVCE2 double positioned, having at its center the conventional ring.

Concerning to the AVCE3

In pictures 32 and 33—The first AVCE3 element, the sealing ring.

In picture 34—The second AVCE3 element, which are the built-in grooves twinned to the conventional groove (at the center).

In picture 35—The AVCE3 double placed, having at the center the conventional ring.

In pictures 36, 37 and 38—The third AVCE3 element (as well as a component to the AVCE4), the pushing spring rings.

Concerning to the AVCE4

In pictures 39 and 40—The first AVCE4 element, the sealing ring.

In picture 41—The second AVCE4 element, the built-in groove, having at the bottom the pushing spring ring and at the center the conventional ring's groove.

In picture 42—The AVCE4 positioned below the conventional ring.

In picture 43—The AVCE4 double positioned, having at the center a conventional ring.

Concerning to the AVCE5

In picture 44—The first AVCE5 element, the sealing ring.

In picture 45—The first AVCE5 element, the sealing ring, in sectioned vision.

In picture 46—The second AVCE5 element, the inferior and upper built-in grooves, and at the center, in perspective, the conventional ring's groove.

In picture 47—The AVCE5, placed above the conventional ring.

In picture 48—The AVCE5 double positioned, having at the center the center a conventional ring.

In picture 49—The AVCE5 double positioned, showing different technical details.

Concerning to the AVCE6

In picture 50 we see the first AVCE6 element—the sealing ring.

In picture 51 the sealing ring element in sectioned detail.

In picture 52 the second AVCE6 element—the built-in groove.

In picture 53 the AVCE6 double positioned, having at the center a conventional ring.

### DETAILED EXPLANATION OF THE COMPENSATIVE RINGS CONCERNING PICTURES

Picture 01 presents AC1, here called “External Embedded”. It is a ring composed by two parts, the inferior—picture 02 (16)—and the upper—picture 02 (17). The inferior has an expansive action and rectangular body in its sectional cut, as well as an outside indent among the tips 02 (19); the upper part 02 (17), also with expansive action and with rectangular body in its sectional cut, presents a bounce 02 (10) in the edge of one side, opposing to the very ring's opening.

Picture 03 shows the inferior ensemble part; picture 04 depicts the upper part; picture 05 presents AC1 Composed Ring assembled and seen underneath.

Looking to those pictures and the assembled ring arrangement of picture 05, one concludes that even with spontaneously wastage occasioned among ring and cylinder bore, the ring will still seal satisfactorily.

Furthermore, industry and manufacturers could adapt easily to this ring model, because its characteristics and flexibility conditions are the same as the actual state of the art, facilitating its assembly in the piston grooves.

In picture 06 one can see the AC2 ring, called “Internal Conjoined”. It is a ring composed by two parts, the inferior—picture 07 (16)—and the upper—picture 07 (17). The inferior part 07 (16), with expansive effect and rectangular body on its sectional cut, has a hollow among the tips 07 (19), from the inside. The upper part 07 (17), also with expansive effect and rectangular body on its sectional cut, has a salience 07 (10) located on the inside of the underside, in order to fit the hollow 07 (19) of the inferior ring (16).

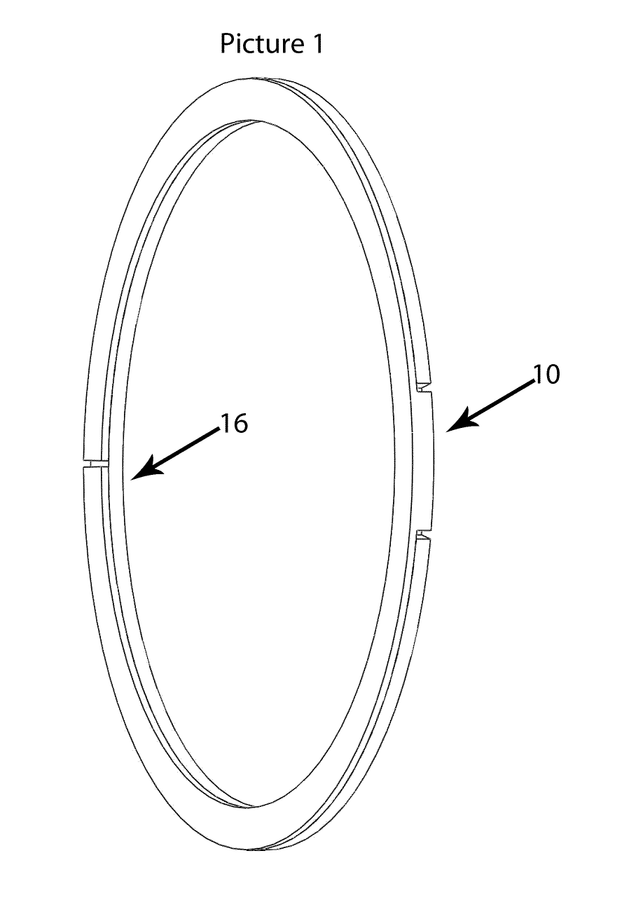

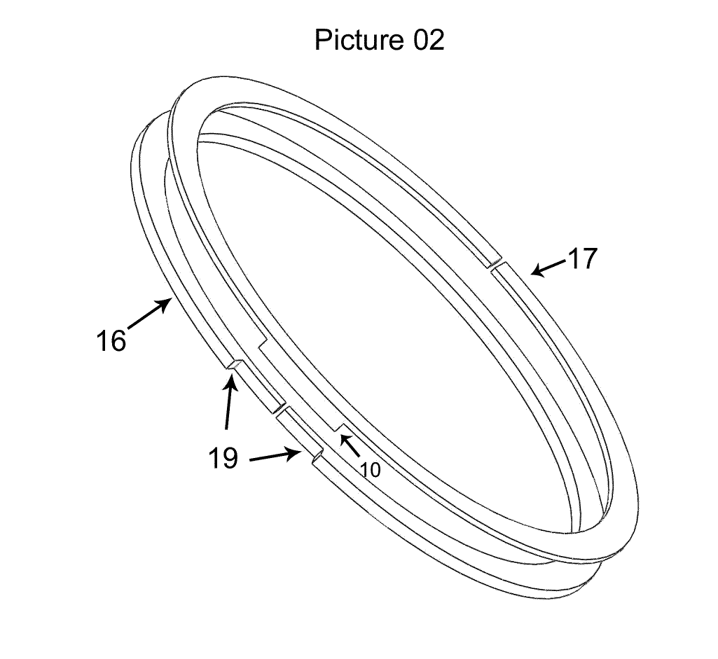

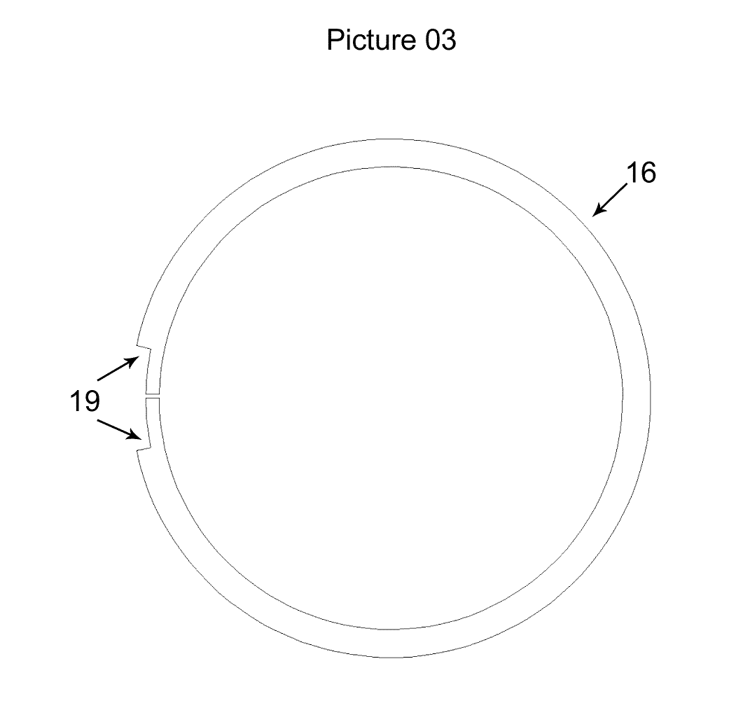

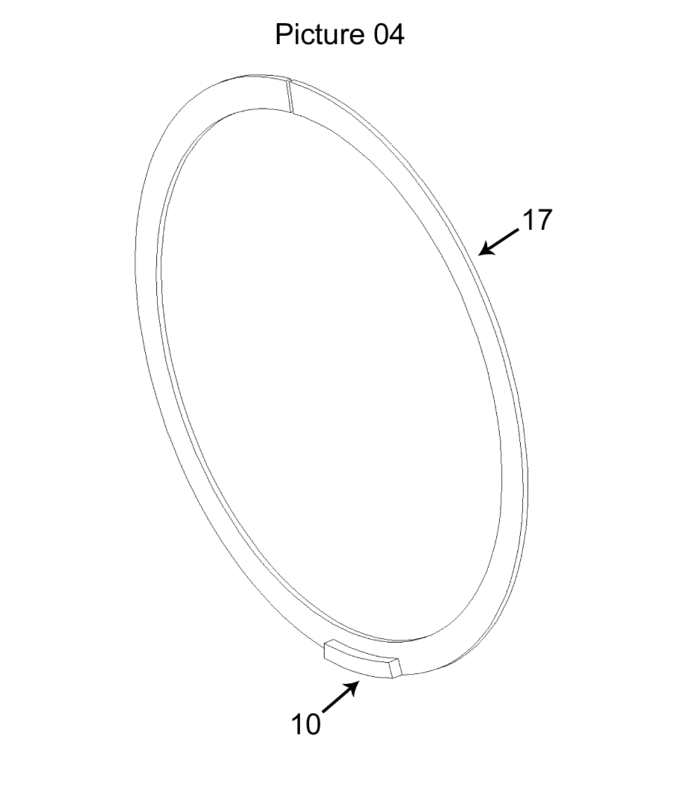

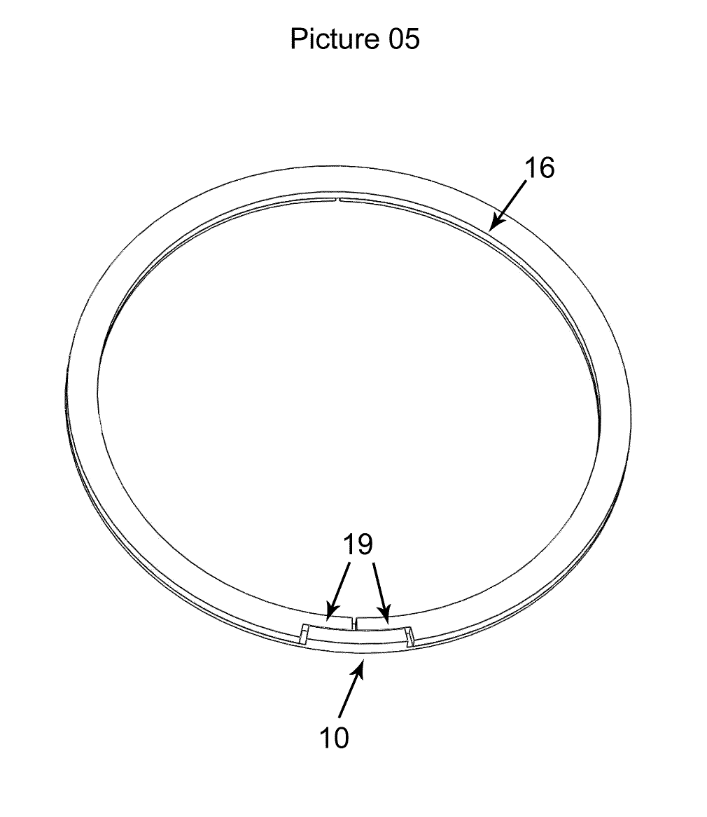

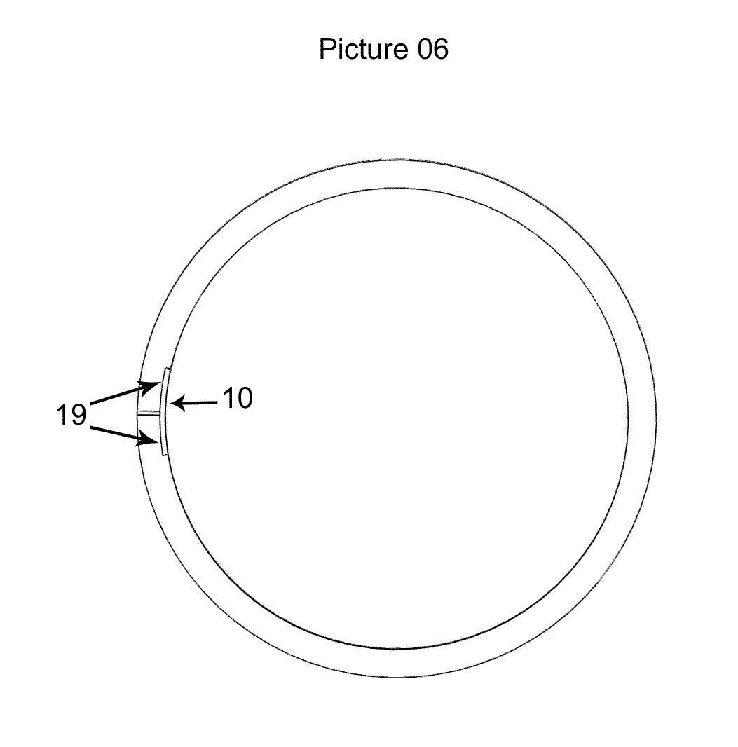

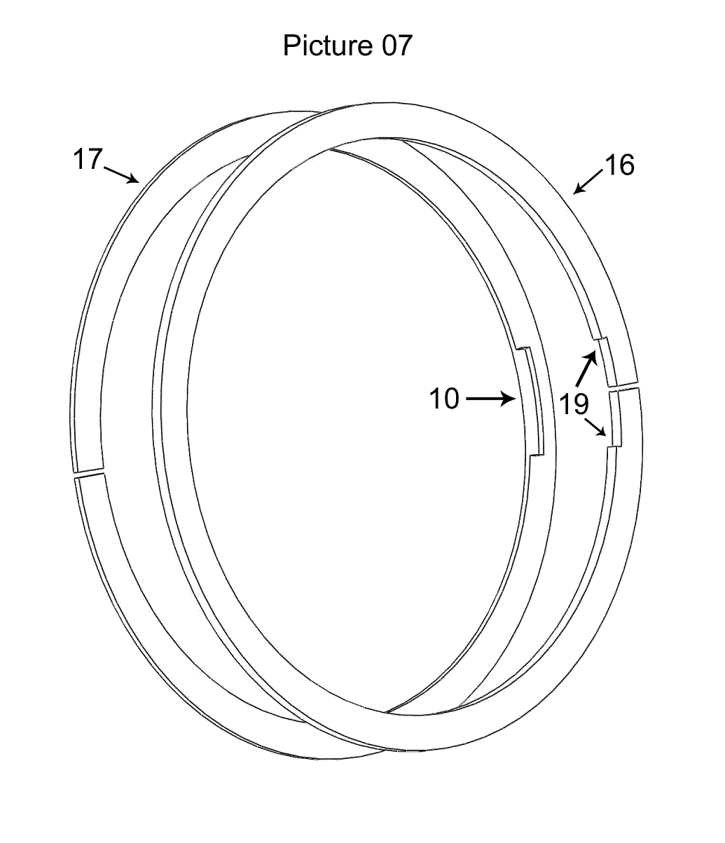

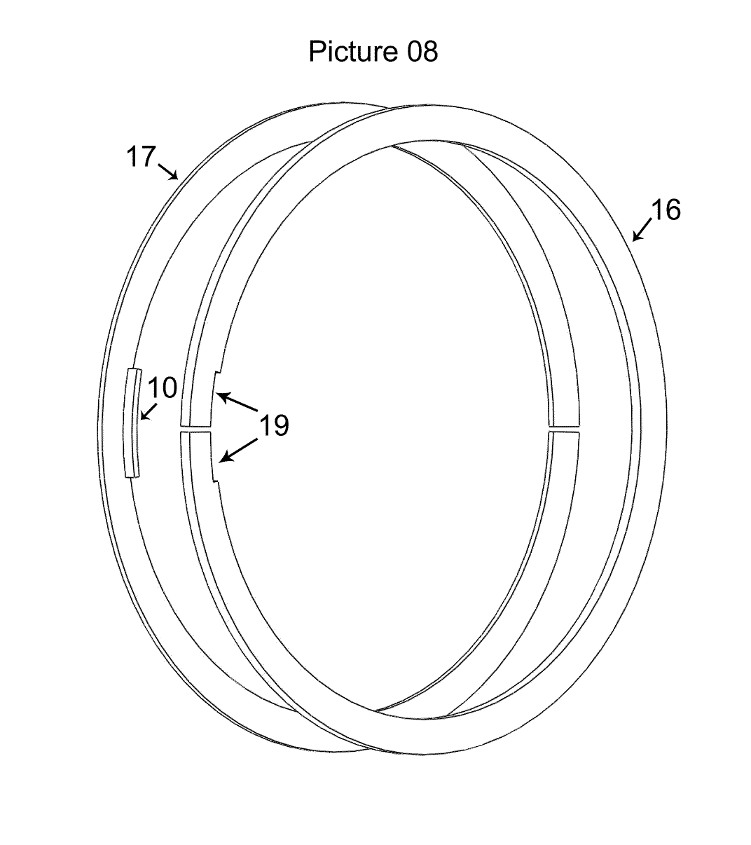

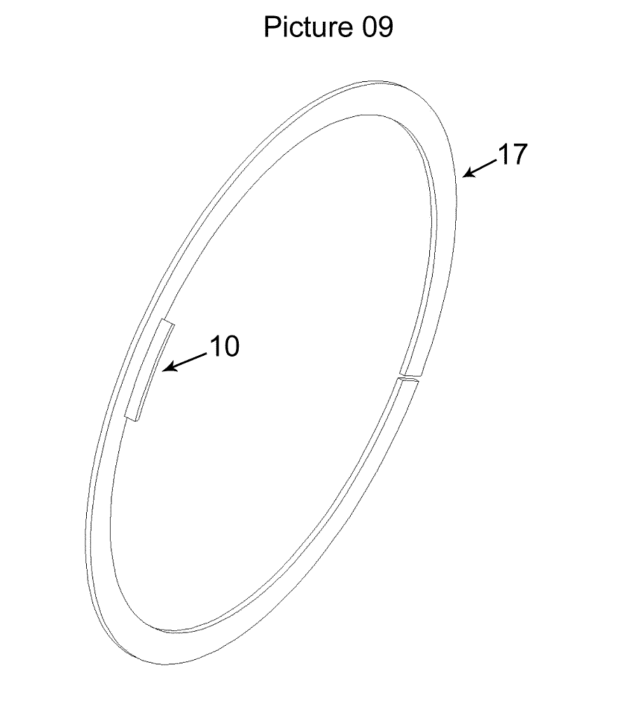

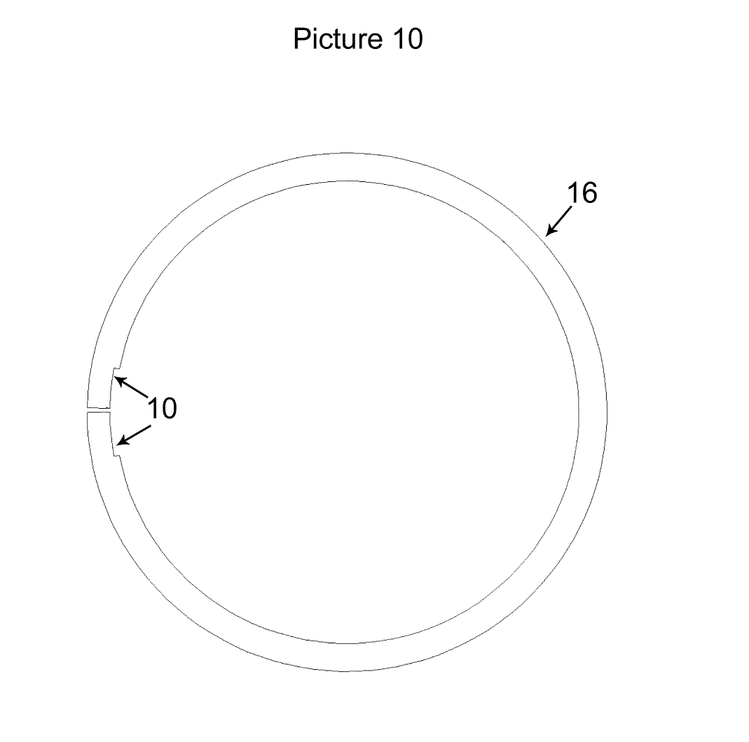

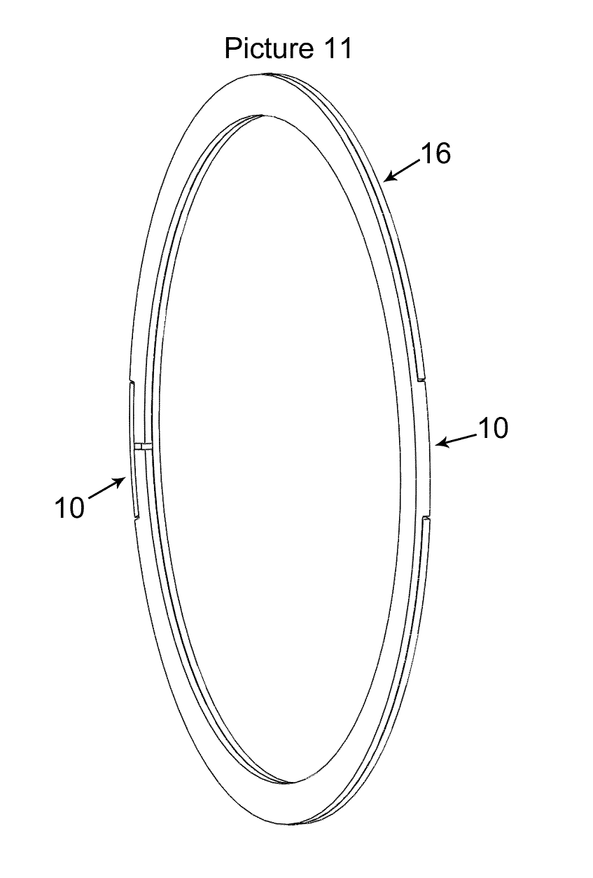

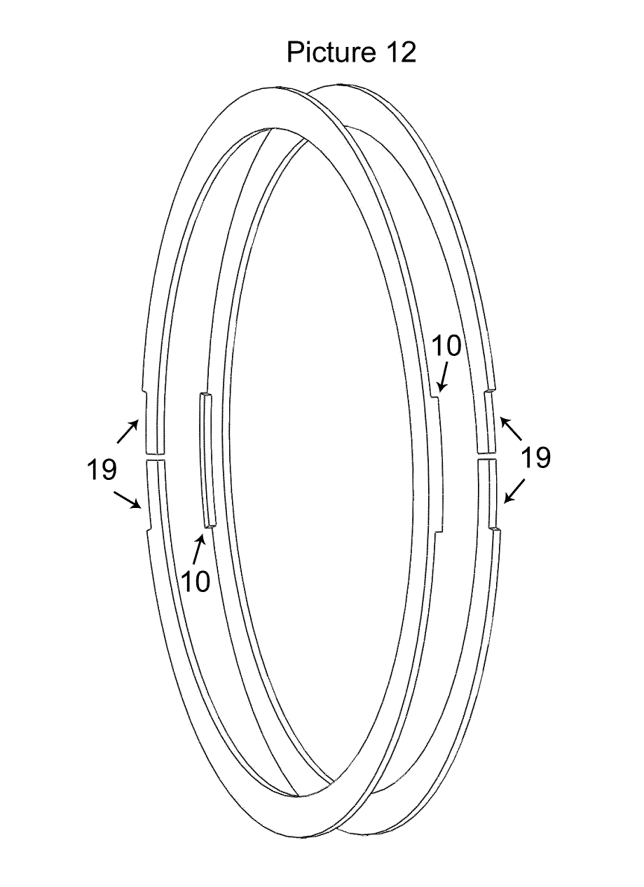

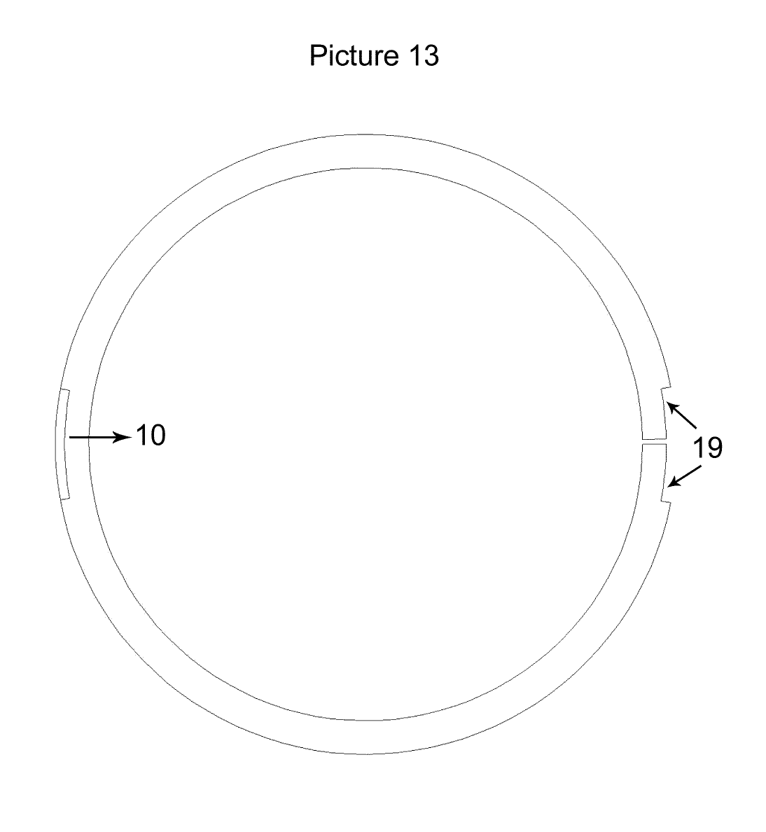

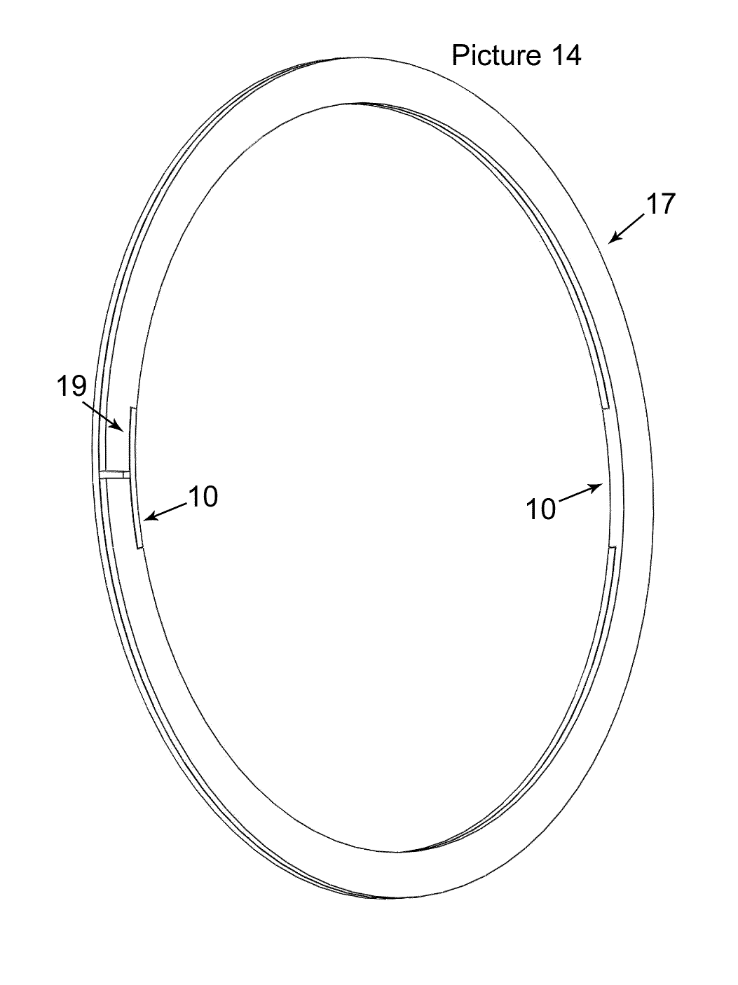

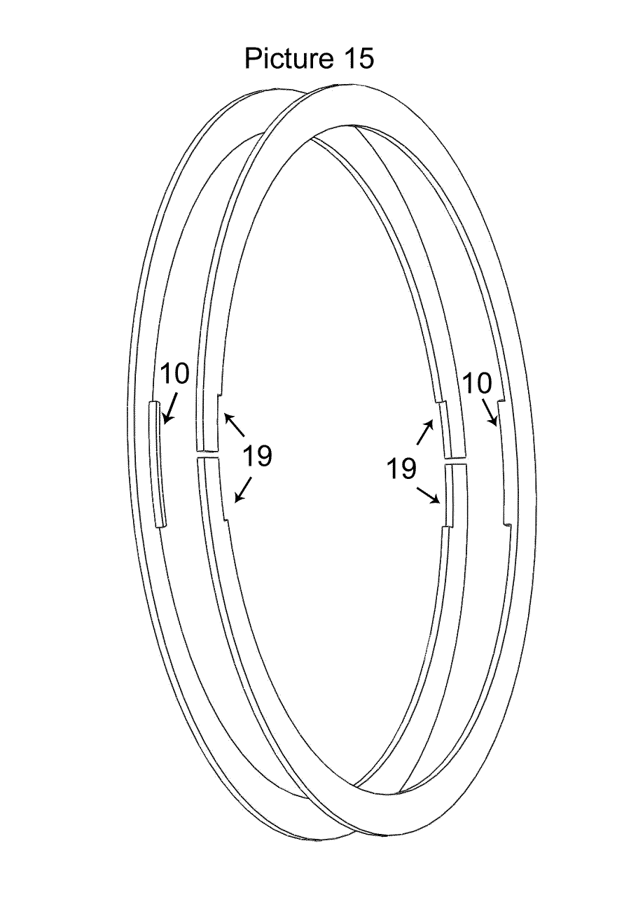

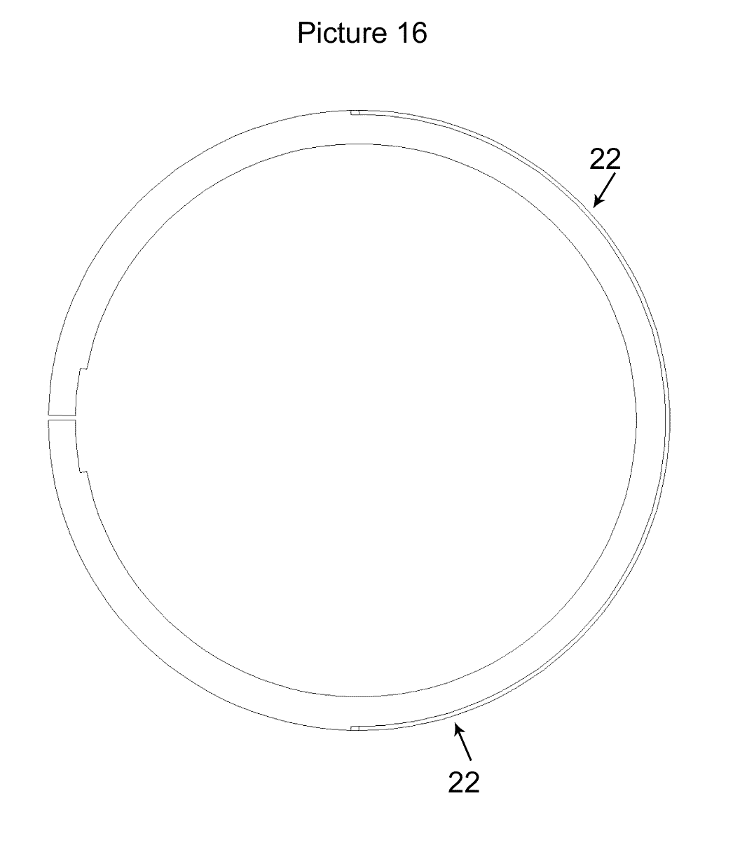

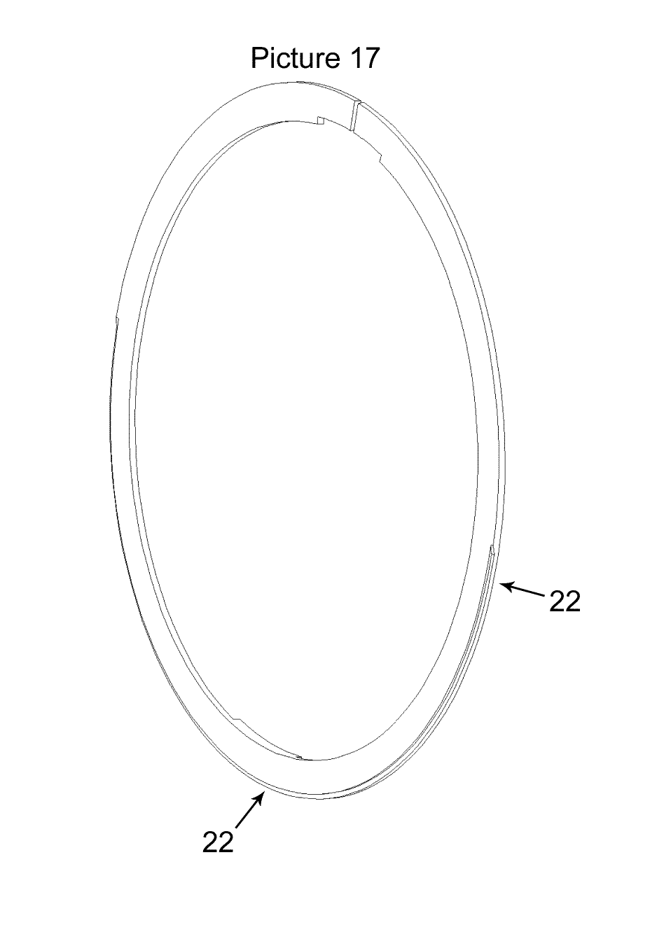

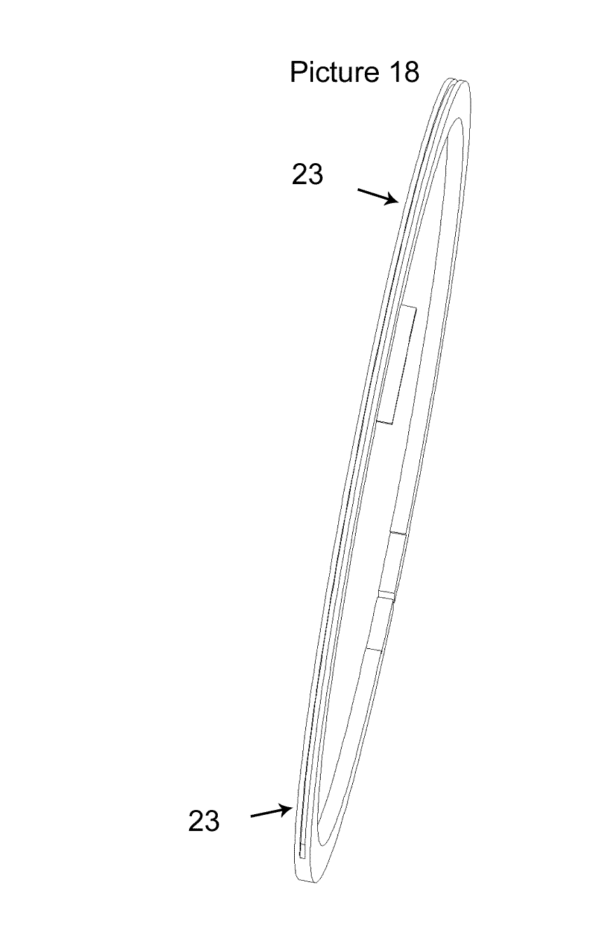

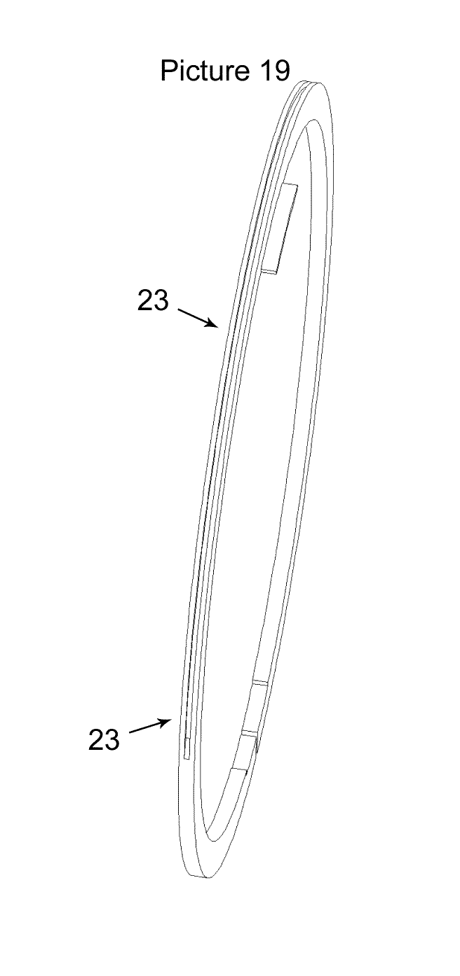

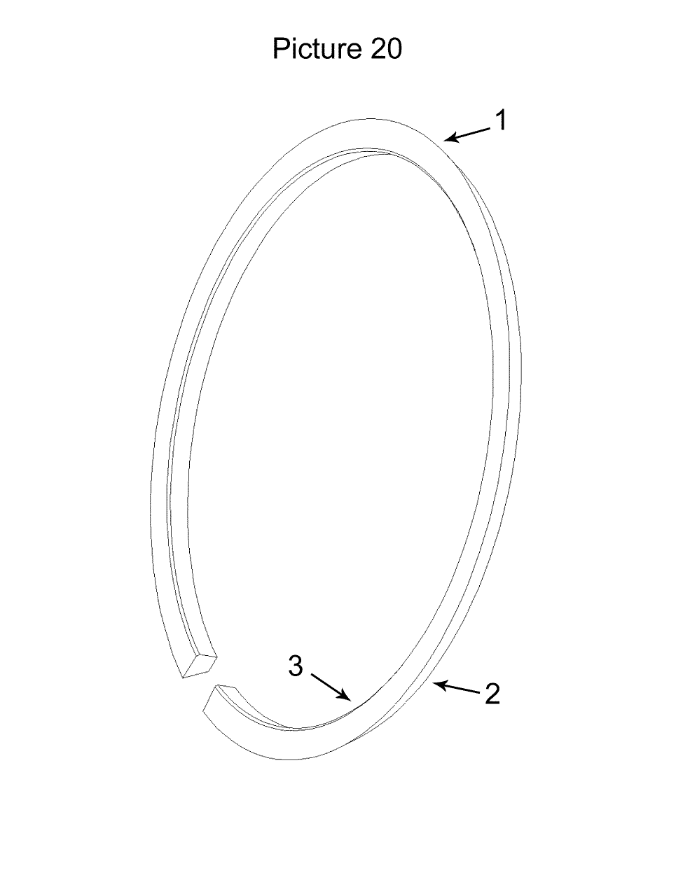

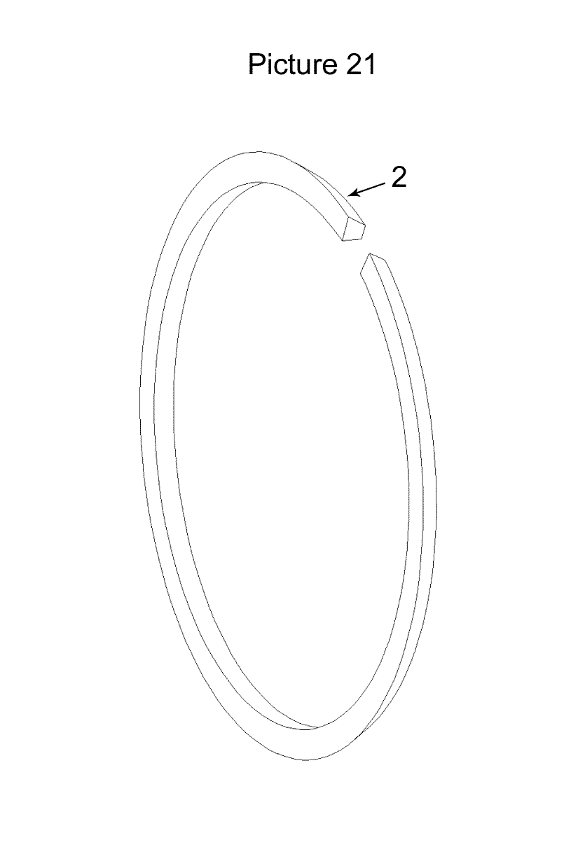

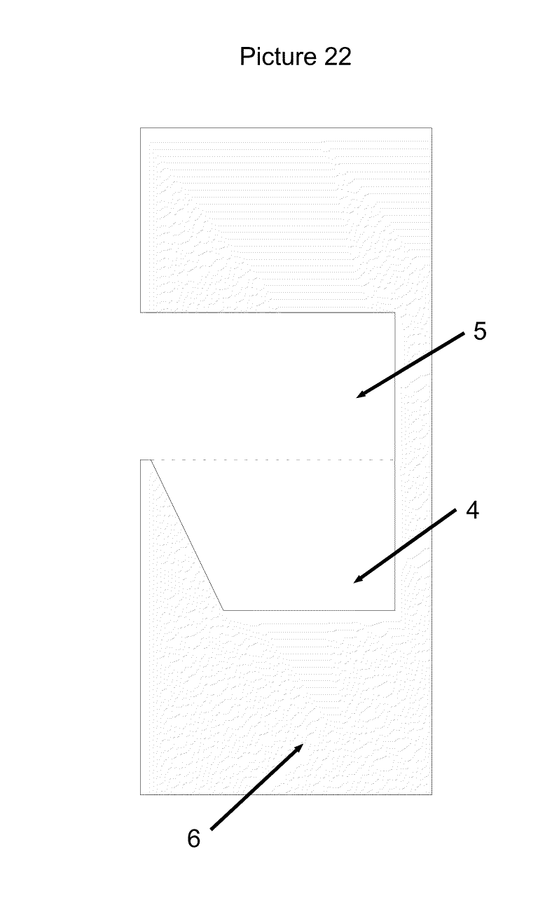

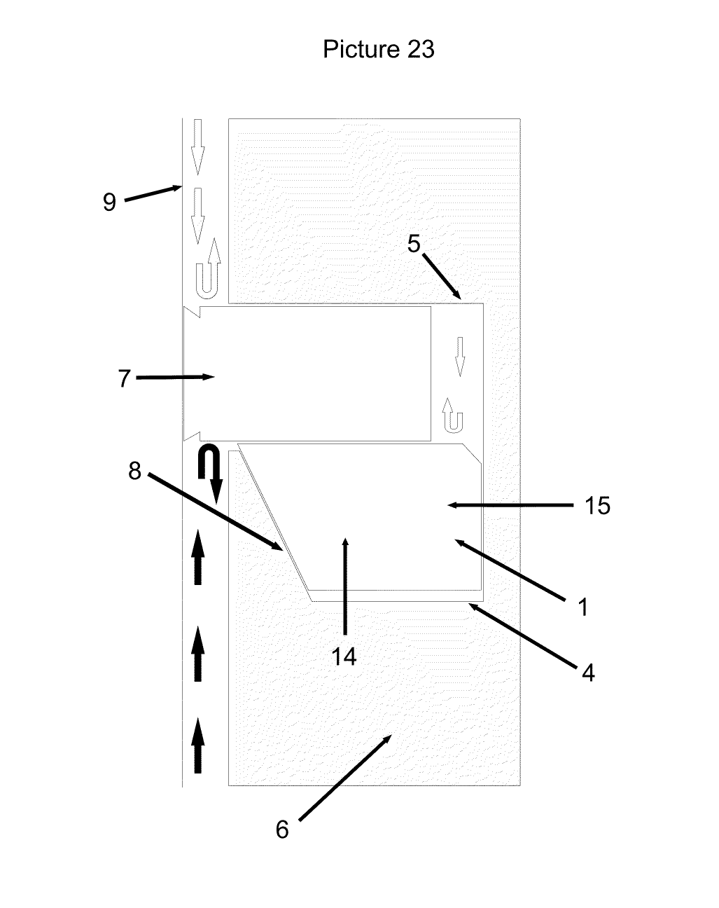

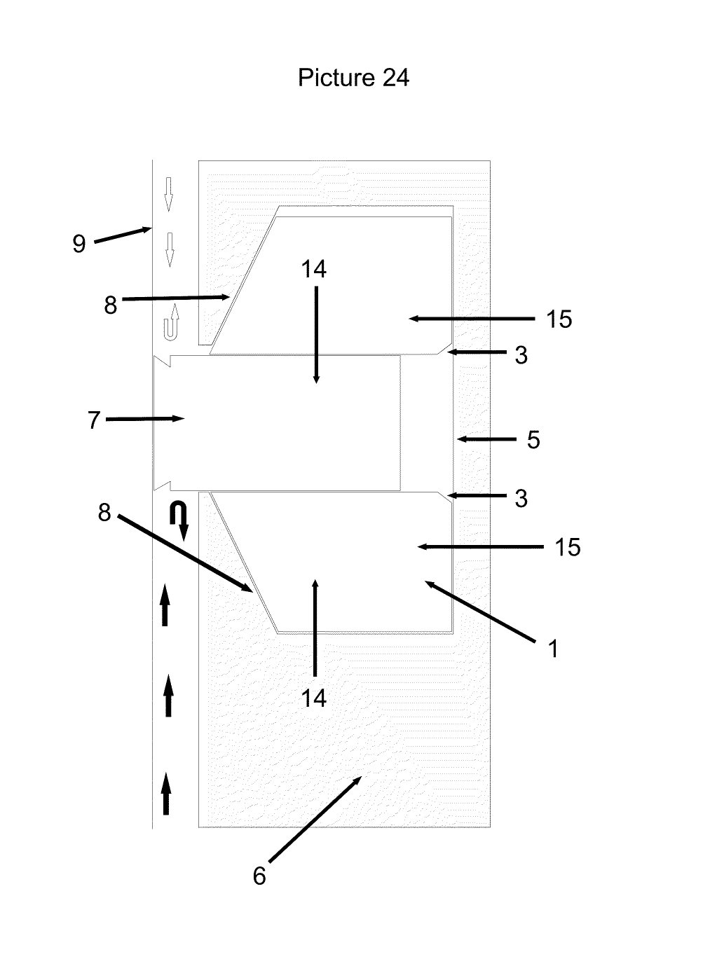

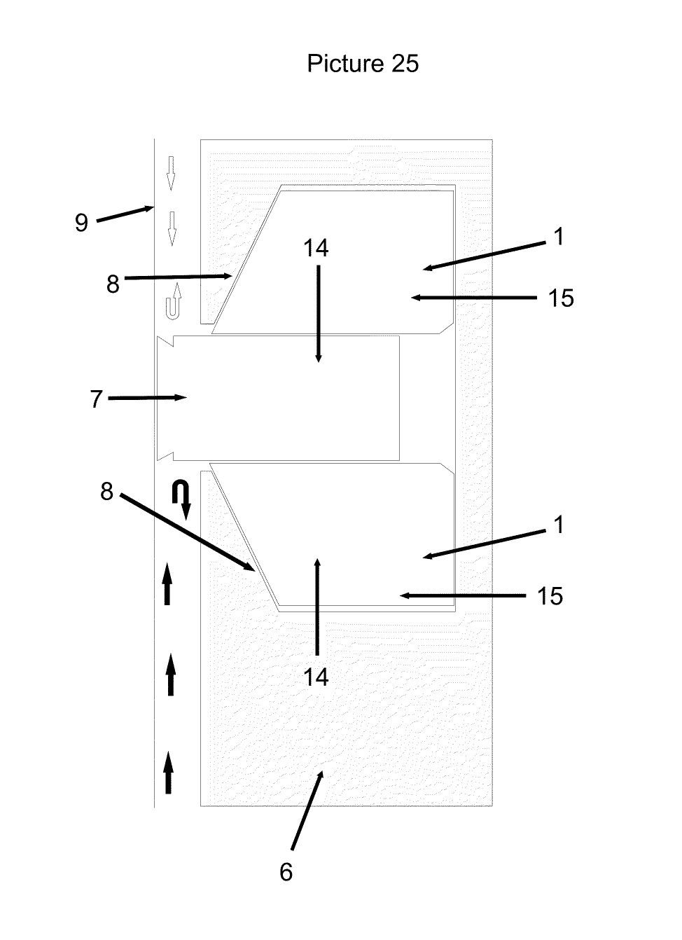

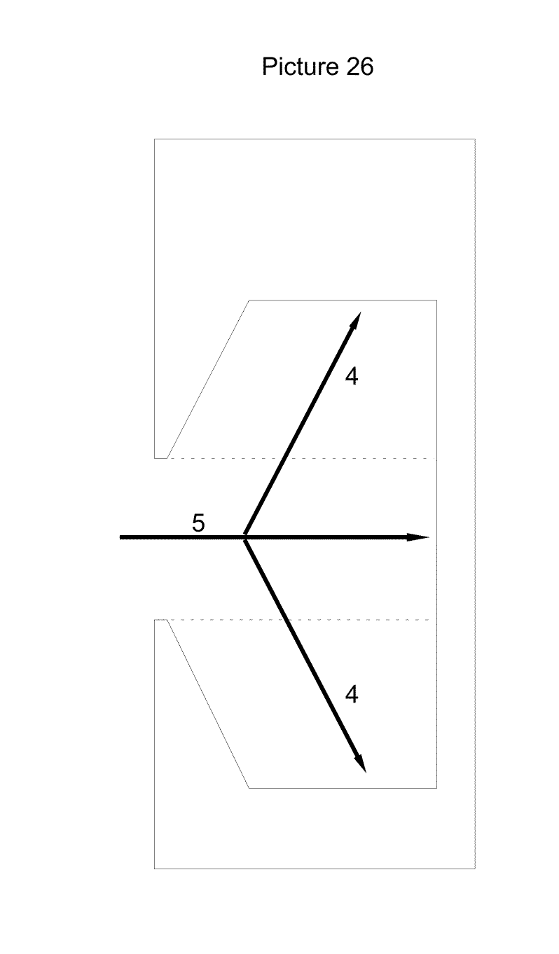

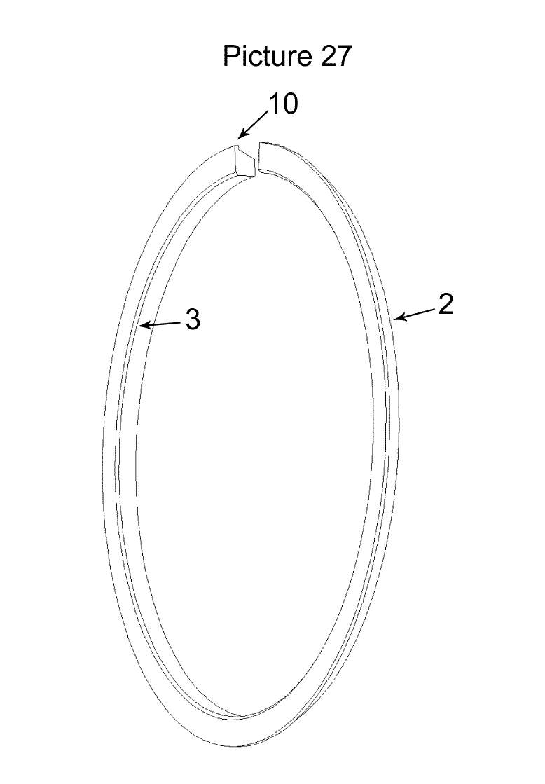

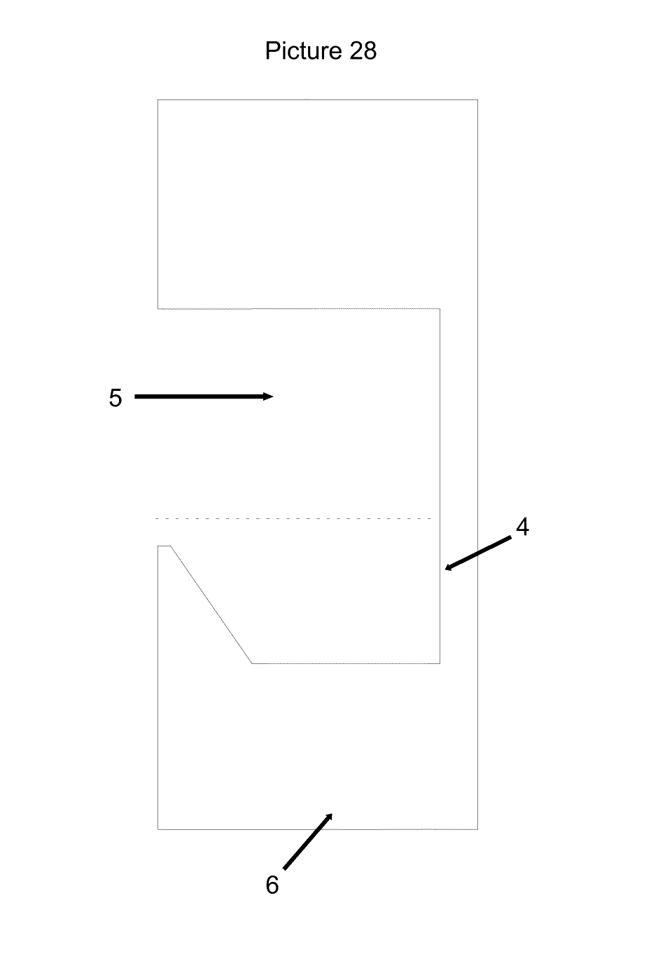

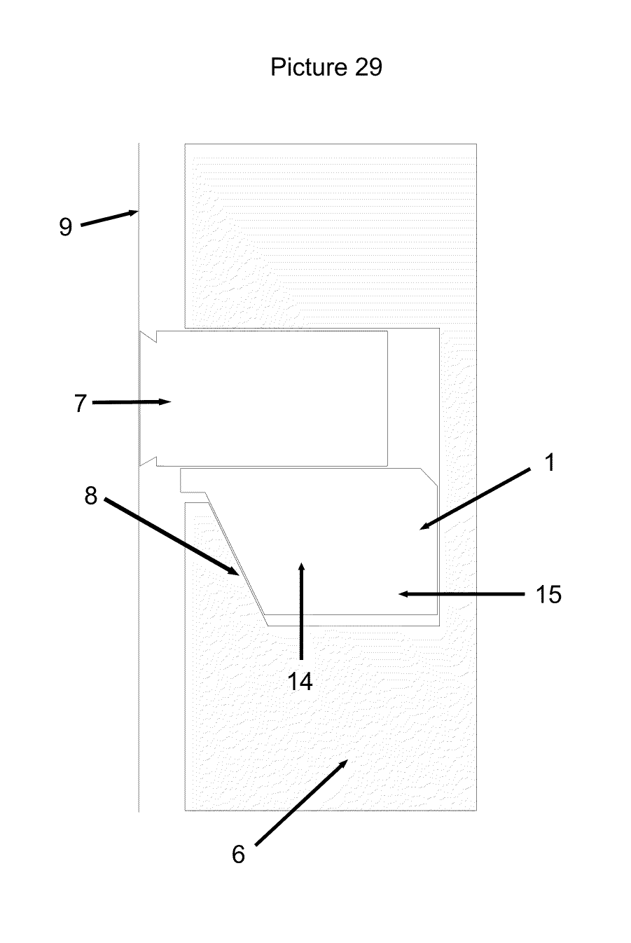

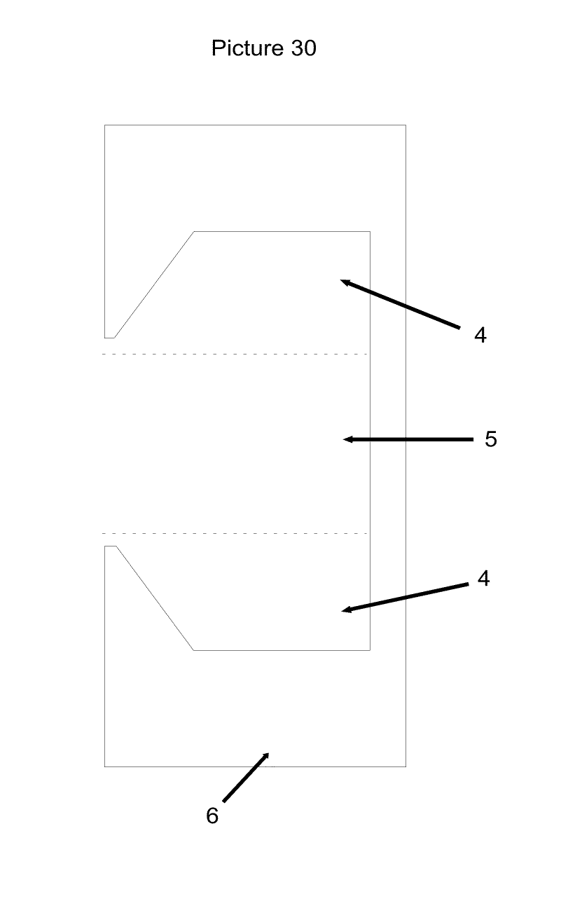

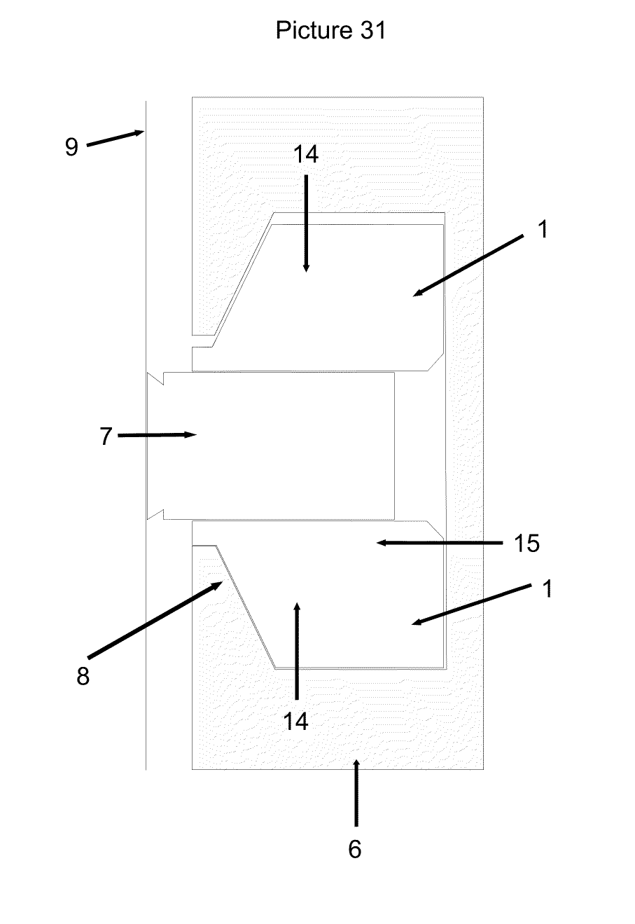

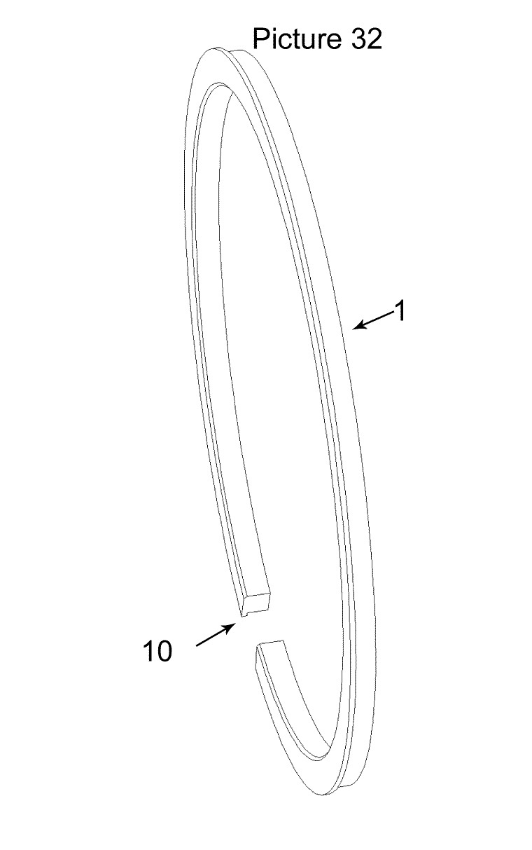

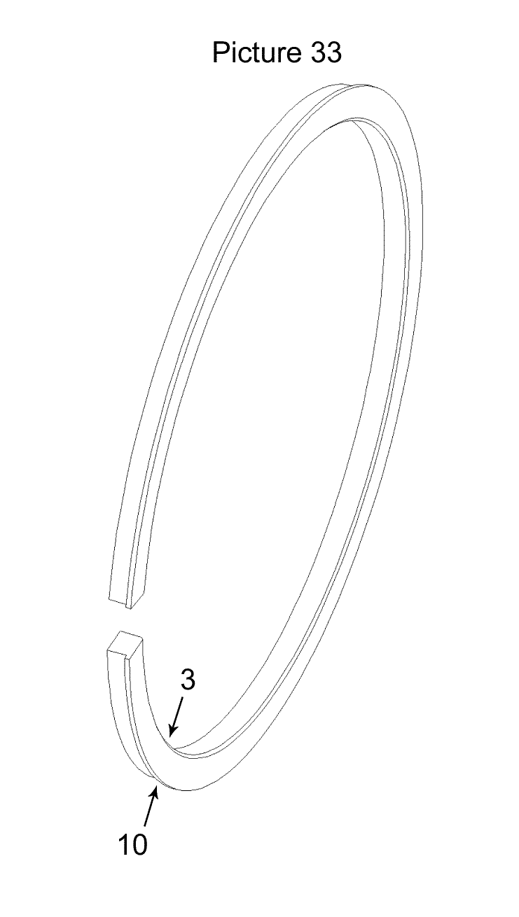

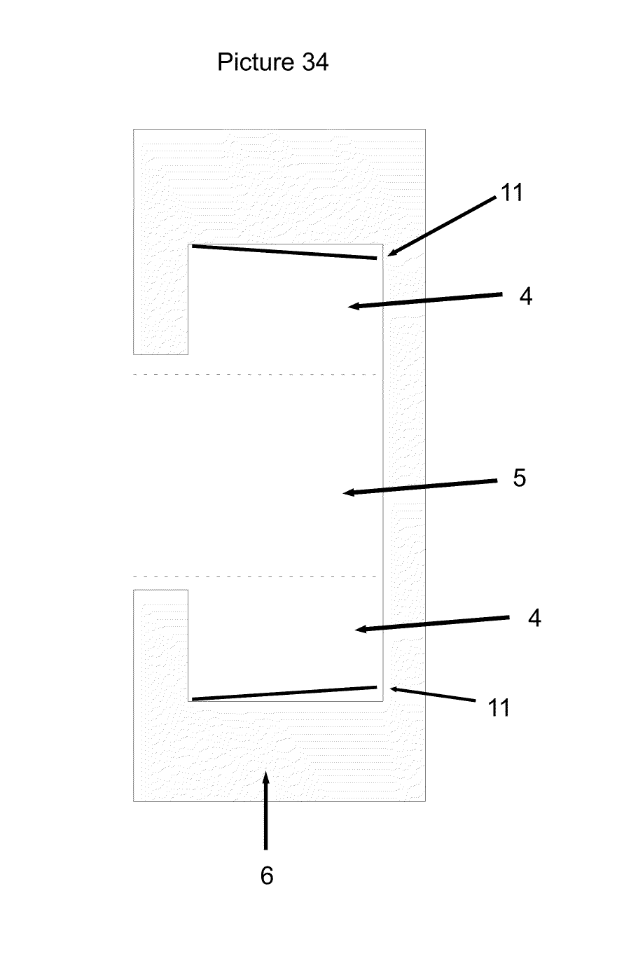

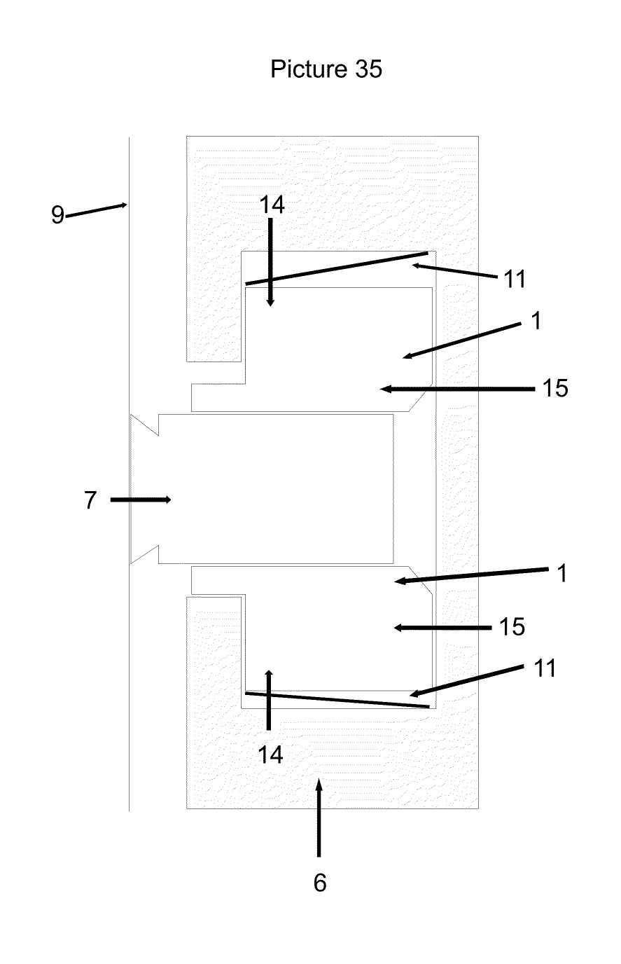

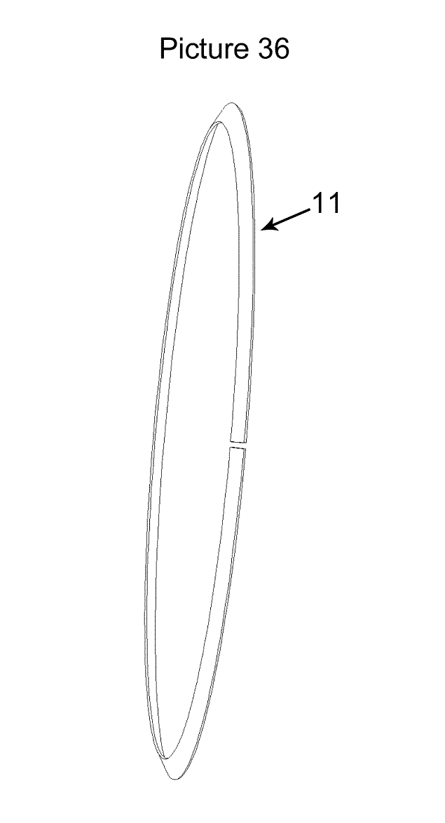

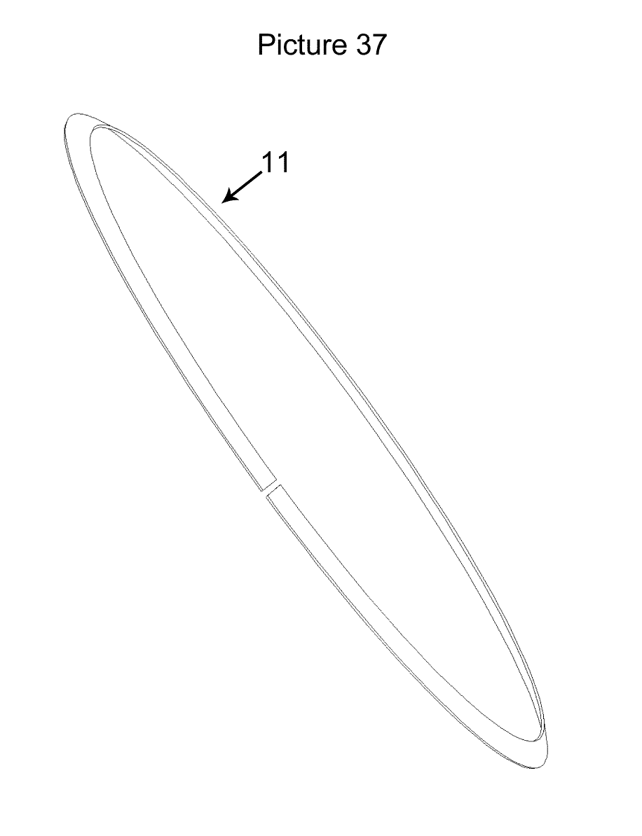

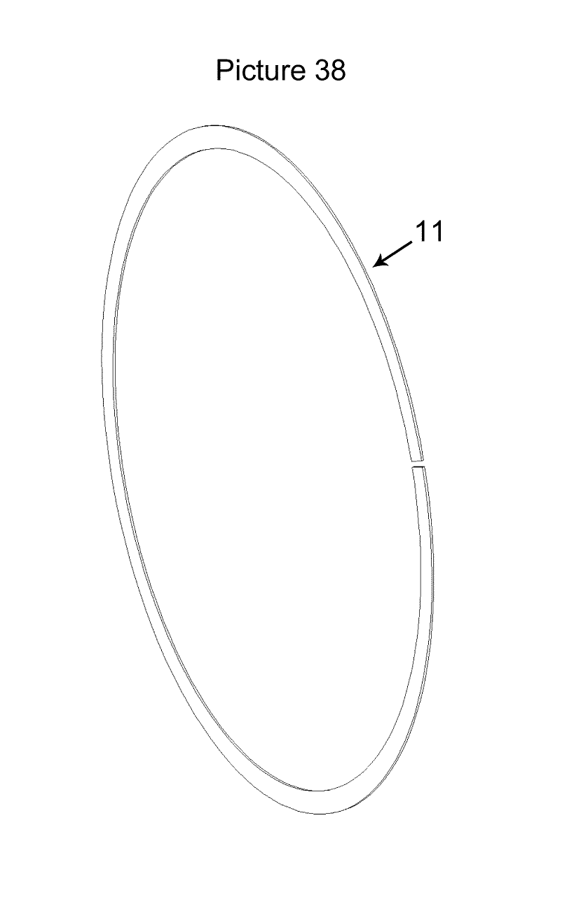

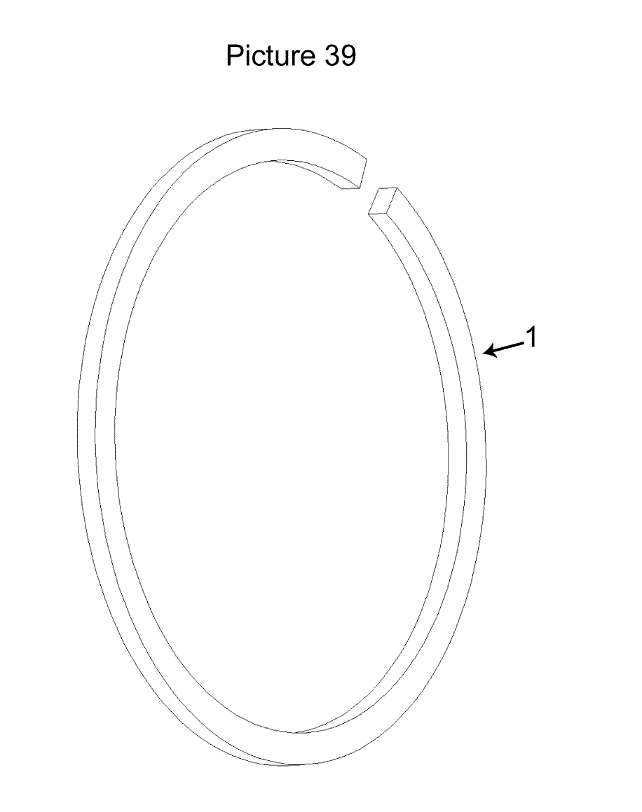

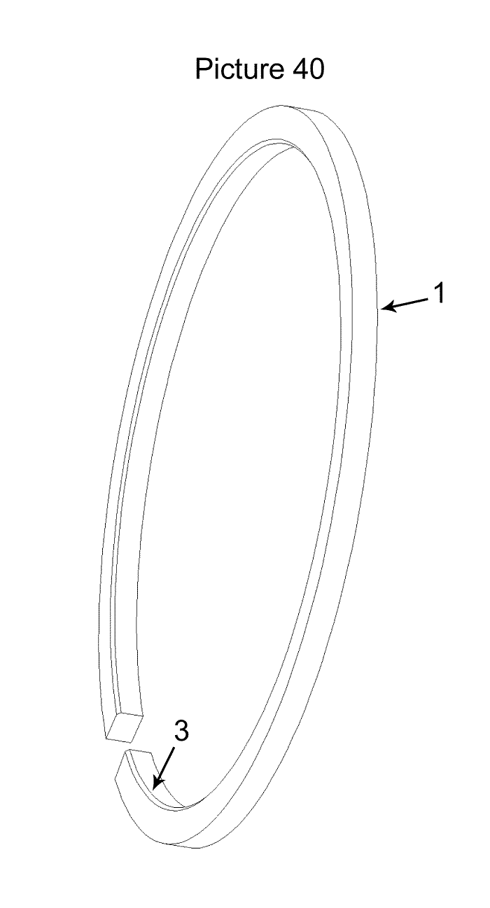

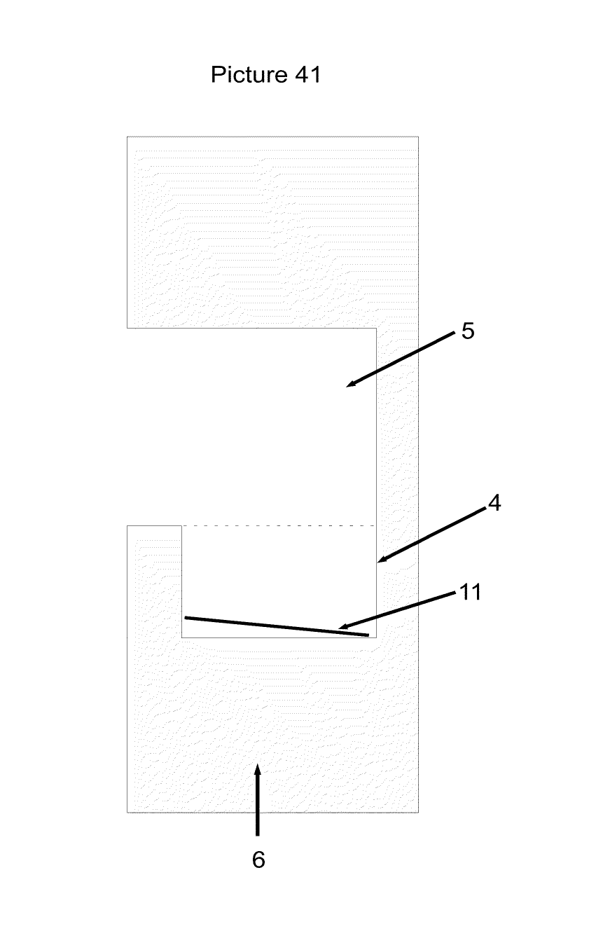

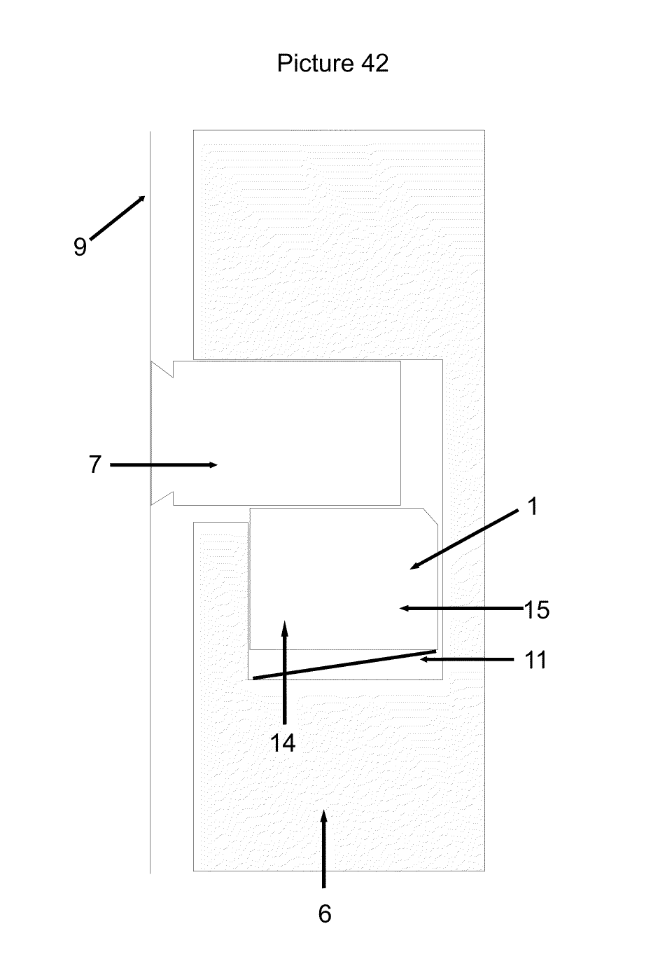

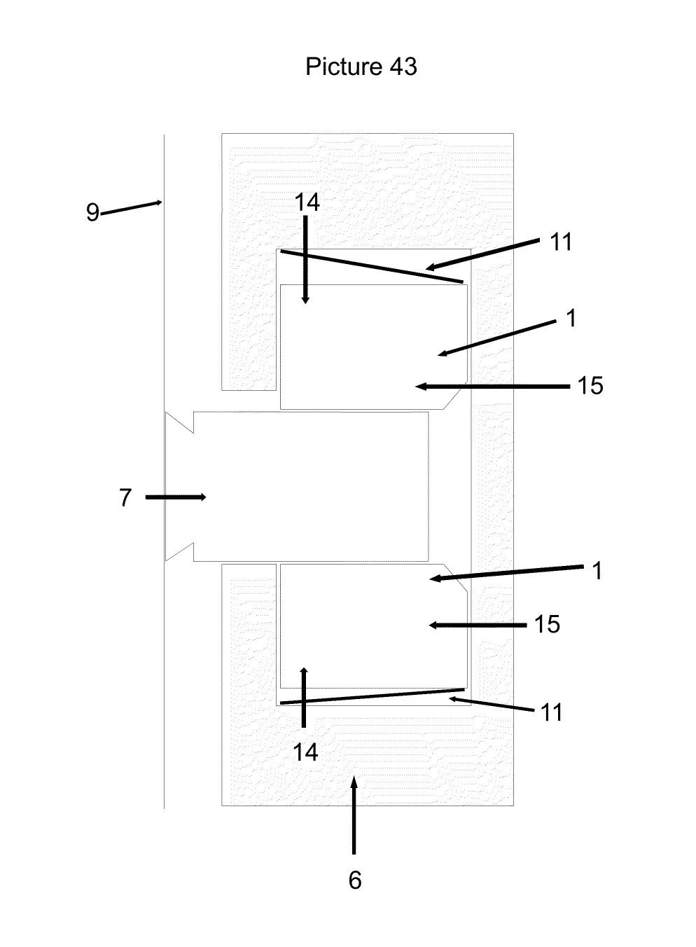

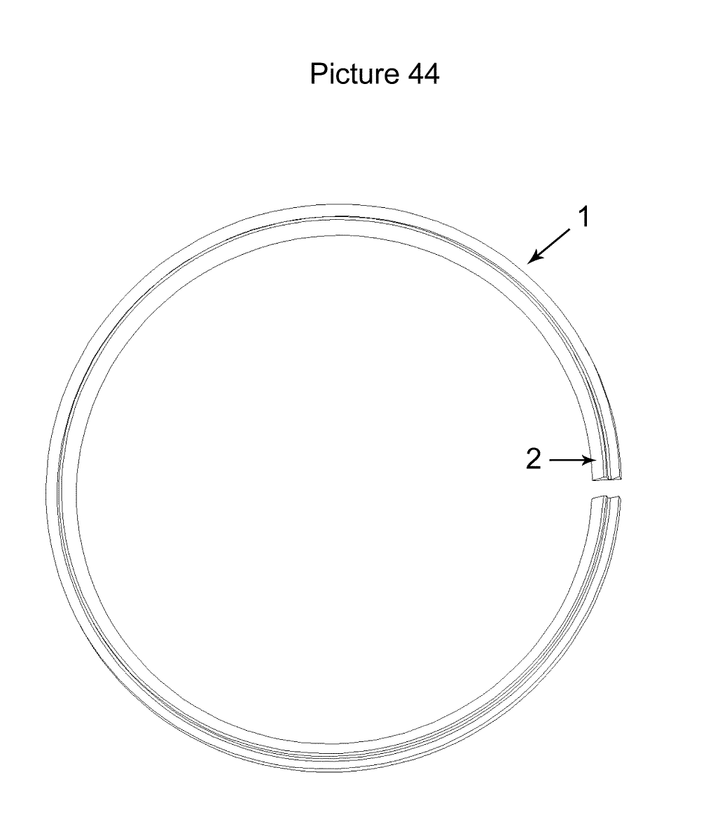

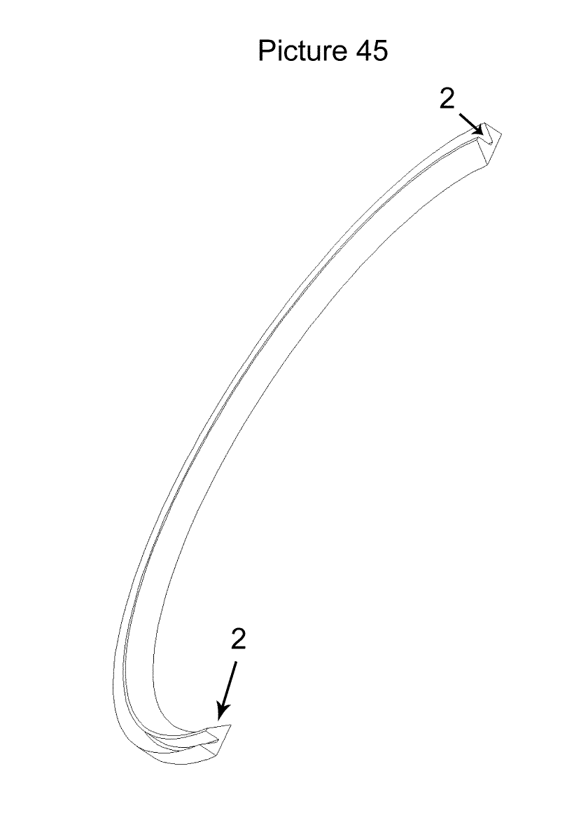

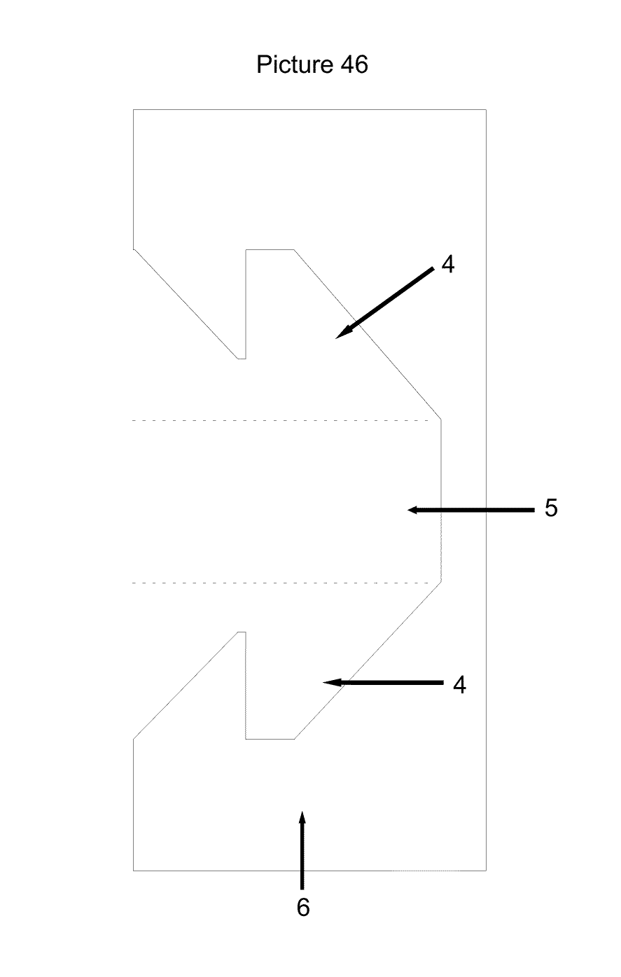

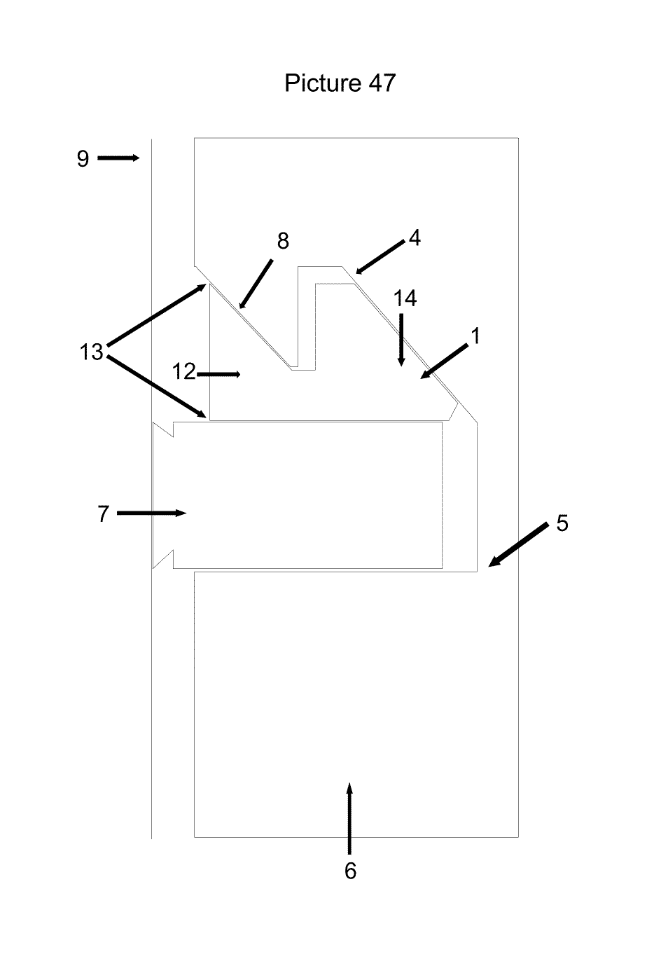

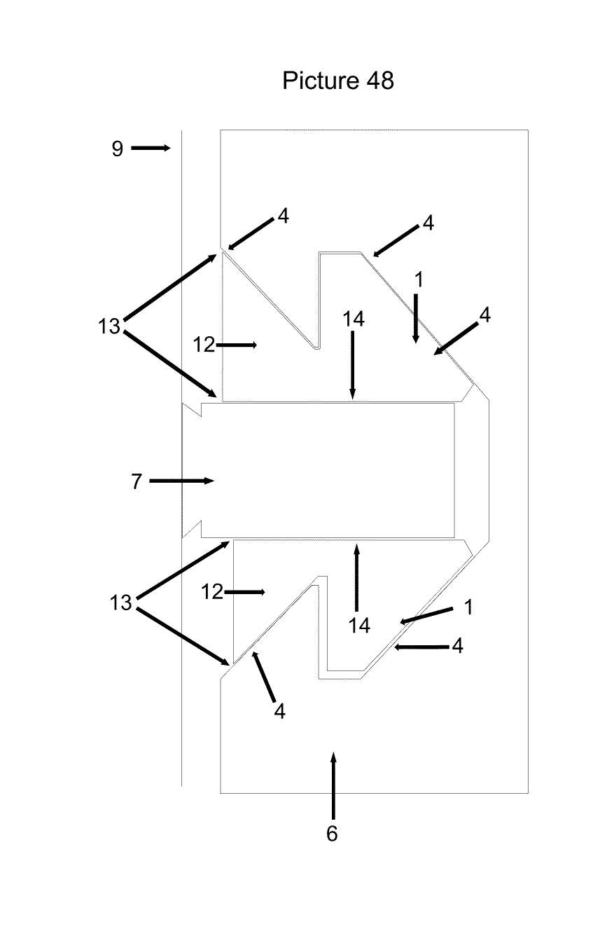

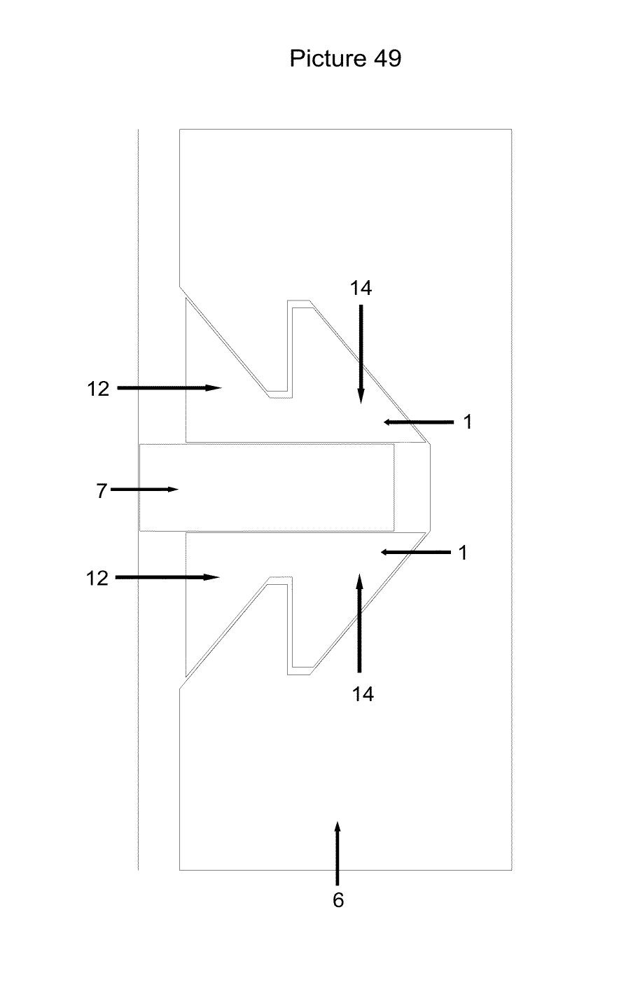

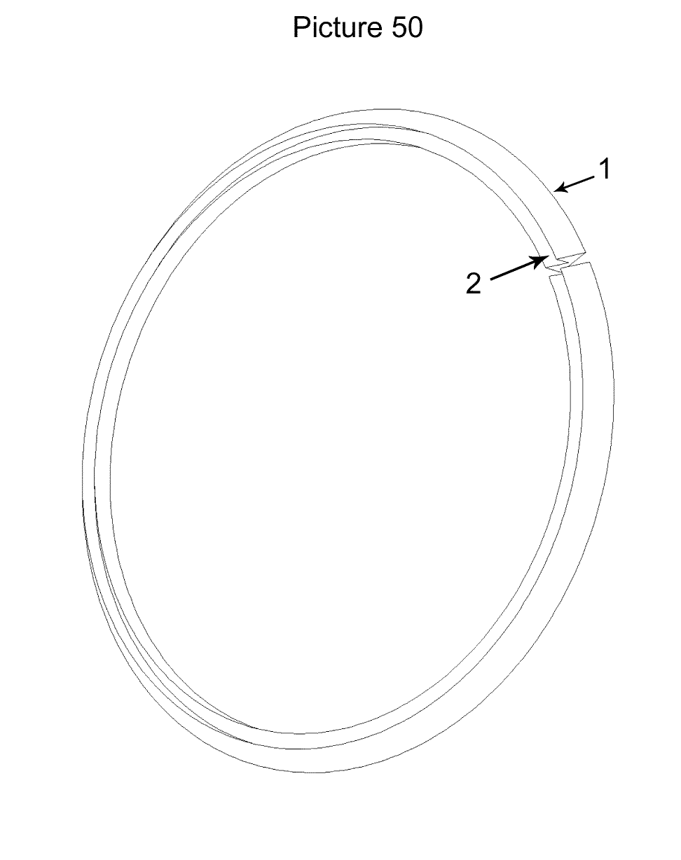

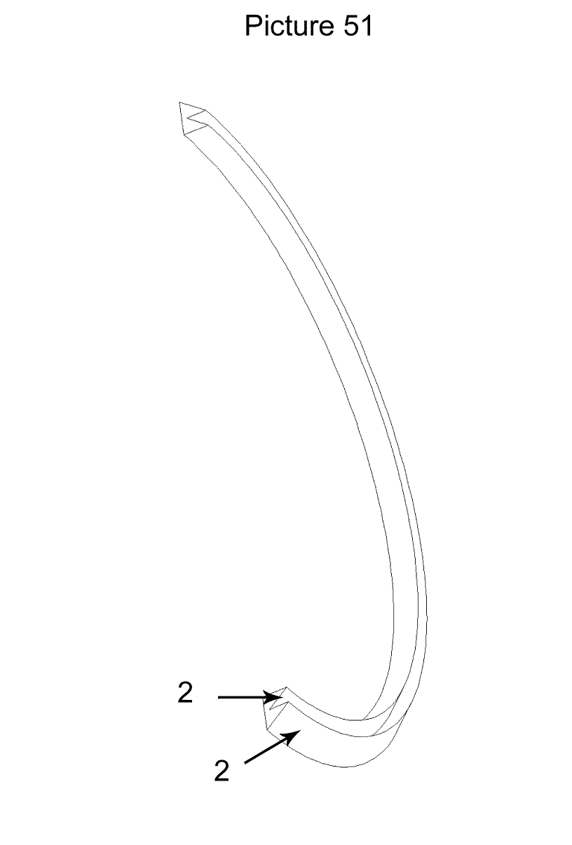

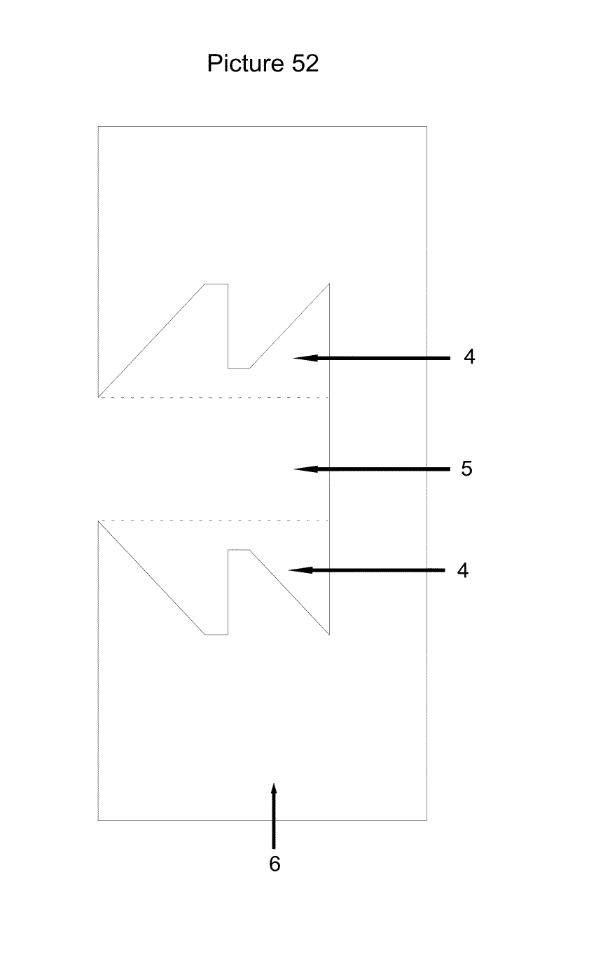

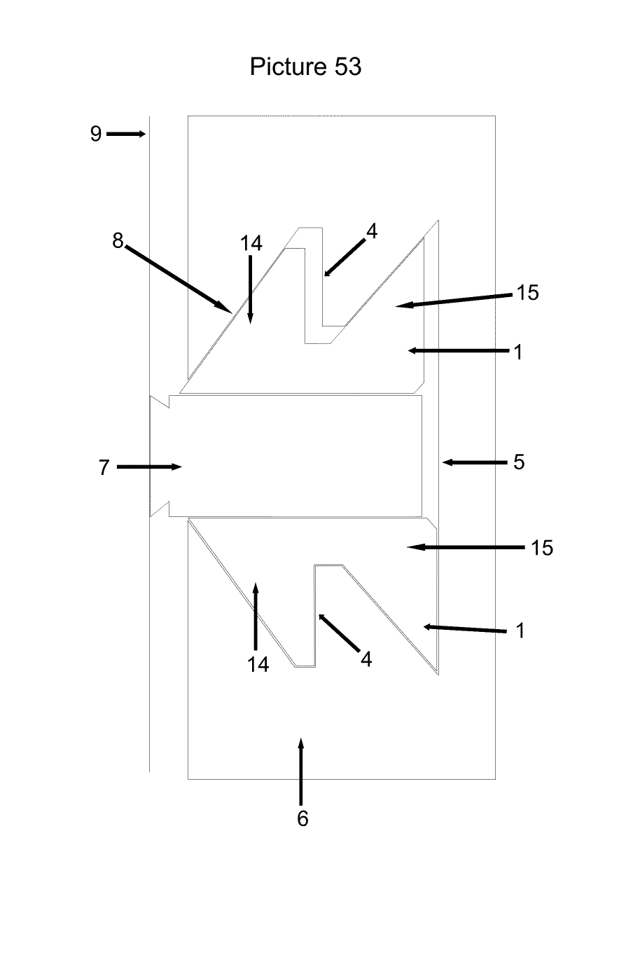

Picture 08 shows both parts in exploded vision. In picture 09 it is possible to see the upper part in small details. In FIG. 10 is possible to see the inferior part completely. This Compensatory Ring model (AC2) and the previous (AC1) will be simple to produce, considering the actual state of the art and the industry machinery. They could be even with the same flexibility and the same thickness, width and height measurement from the actual ring models, but bringing an advantage: self-adjustment when facing natural wastage.

In picture 11 is depicted the AC3 compensator ring, here called “Double External Conjoint”. As one can see, it is a ring composed by two perfectly equivalent and equal parts that fit evenly together—as noticed in picture 12 in exploded vision. One can also notice in both ring tips the external edge saliencies 12 (10), and the external indents at the ring tips in picture 12 (19).

The picture 13 exposes one of AC3 components, where one can see the ring's external salience 13 (10) ant the indent at the ring tips 13 (19).

Applying logical reasoning, one can conclude that even with natural wastage between ring and cylinder bore, this composed rings disposition will keep blocking oil and gas leaking, thanks to its compensatory self-adjustment.

In picture 14 is shown the AC4 compensatory ring, also known as “Double Internal Conjoined”. It is a ring composed by two evenly equal parts that fit together perfectly, as depicted in exploded vision in picture 15. Both parts have saliencies or protrusions at their internal edges 15 (10) and internal indents at the tips 15 (19).

Picture 16 (22) shows components of the AC4 ring with optional demoted detail 17 (22) which can reach until 180° extension (all across the ring), always placed aside the salience. Pictures 18 (23) and 19 (23) depict an optional groove detail which might get to 180° extent in the external side of the ring, always placed in the salience region (10).

### Technical Explanation of the Demoting Details and Grooves Placed in the Ring

Since some work situations rings might show a greater wastage in tip region than in the middle area (and contrariwise), the option to the usage of these resources will give the reliability of an uniform rings set abrasion, among the indent (19) and the salience (10) areas, since the ring, being thinner in the salience area (10), will waste more easily than in the tips, where is the indent 19. The salience (10) leaning in the indent 19 prevents the unequal wastage among parts and contrariwise.

Applying the same logical reasoning made to the three previous models, one can conclude that AC4 is the highlight, the culmination of the invention.

### Detailed Explanation of the Sealing Rings Pictures

Sealing Rings in Built-in Grooves—AVCE1

Pictures 20 and 21 illustrate one of AVCE1 components, the sealing ring (1), with expansive and propulsive action, rectangular-trapezoid shaped in its sectional cut, with inner inclined border (3) and trapezoidal inclination (2) whose angle could vary according to the designer's will.

In picture 22 one can see the second AVCE1 element, which is the built-in groove (4) in the piston (6). It has compatible outlines in order to fit accordingly—picture 23—its sealing ring element (1), that once embedded in the built-in groove (4) serves as pulling base to the conventional ring (7), that appears in the picture leaned against the cylinder bore shirt (9).

In picture 23 is the AVCE1 technical considerations, downwardly, and the piston (6) sucking in the explosion mixture. One can see the conventional ring (7) placed in the top side of the groove (5); in the bottom side, touching the conventional ring (7), the sealing ring element (1). This sealing ring element, due to its expansive action (15) and the compatible inclinations—as seen in (8)—has a constant and moderate propulsive force (14) towards the conventional ring (7), thus preventing the oil leak—indicated by the filled arrows—as well as the gas leak (blow by) by the top, indicated by the blank arrows. The cylinder bore shirt is depicted in (9).

In picture 24 one can see the AVCE1 in double composition, the lower (1), and the top (1), doing double protection, with the piston (6) in maximum height, at the explosion moment. Here is shown the efficiency point of this invention: the conventional ring (7) oscillating inside an oscillating groove, formed by two AVCE1 that follow their movements, thus sealing both gas (blow by)—phenomenon indicated by blank arrows—and oil—phenomenon indicated by filled arrows. The top AVCE1 (1) went down to compensate the conventional ring's oscillatory movement (7).

In picture 25 is depicted what could be called an intermediary moment of the conventional ring (7). It is the oscillatory movement that the referred ring (7) does when the piston (6) starts the downwards movement after the explosion (blank arrows). It will stop gas (blow by) and oil (filled arrows) from leaking through lower (1) and top (1) AVCE1.

Considering points about the efficiency of this invention patent in picture 24:
a) It is a self-adjusting system. Considering the piston (6) on its lateral movements due to the necessary gap inside the cylinder bore (9). It generates a constant attrition among the conventional ring (7) and the groove (5) where it is placed; in this system it is replaced and is now composed by the mobile AVCE1 lower (1) and top (1). These elements do not allow the appearance of looseness between parts—even with wastage —because they exert a constant propulsive force (14) against the conventional ring (7).
b) The chamfers (3) in the top of the internal edge of the AVCE1, AVCE2, AVCE3, AVCE4 and AVCE5 were projected in order to avoid the formation of “steps” and wear grading, which could appear if this providence would not be made.
c) A tiny amount of oil will leak to the great cavity—picture 26—which houses the three elements previously described. This will be beneficial, for it will grease and oil the system.

The Sealing Ring in Built-in Grooves—AVCE2

In picture 27 one can see the first AVCE2 element, the sealing ring (1), rectangular shaped, trapezoidal (2), with inclinations that could vary in angle according to the designer's will, and with a rectangular salience (10) on its top external edge and a bevel or a chamfer (3), with expansive and propulsive action.

In picture 28 is shown the second AVCE2 element, the built-in groove (4), on the piston (6). As one might see, it has compatible contours to the perfect fit of its sealing ring element—picture 29 (1)—, which once fixed serves as backboard base to the conventional ring (7), that appears against the cylinder bore wall (9) in picture 29.

In picture 30 is depicted the second AVCE2 element, seen in double position as a great cavity that, in perspective, evidences in the bottom the built-in groove (4), in the top another built-in groove (4) and in the middle, also in perspective, the conventional ring's groove (5).

Technical considerations about AVCE2:
a) It is a small deviation of the AVCE1, whose difference lies in the top, on its external edge—picture 27 (10)—, where stands a rectangular-shaped salience.
b) The AVCE2 is self-propulsive, as AVCE1, because it has expansive action and inclinations—picture 27 (2)—which in contact with the compatible bended part of the groove—picture 29 (8) produces a propulsive force (14) that leads it to always compress the conventional ring (7), following its constant oscillations.
c) In dual working, seen in picture 31, the same technical considerations already exposed above and in pictures 23 and 24 in regard to AVCE1 apply, when AVCE2 is placed in the bottom (1) or in the top (1) of the conventional ring.

The Sealing Ring in Built-in Groove—AVCE3

Pictures 32 and 33 shows one of the AVCE3 components, the sealing ring element. It has expansive action, rectangular shaped on its sectional cut, and a salience 33 (10) in rectangular form on its top external edge, and a chamfer on the top internal edge—picture 33 (3).

In picture 34 is shown the second AVCE3 element, the built-in grooves, depicted in perspective; the bottom (4) and the top (4) on the piston (6), plus the bottom and top propelling spring ring (11). To the middle the conventional ring's groove (5) seen in perspective. As one could see, this great groove has contours that fit and notch perfectly to the sealing ring elements—depicted in picture 35 (1). Those, once accommodated, serve as a backrest to the conventional ring—seen in picture 35 (7), and appears touching the cylinder bore wall in picture 35 (9).

Technical considerations about AVCE3:
a) Differently from its predecessors AVCE1 and AVCE2, the AVCE3 are not self-propellant towards the conventional ring—picture 35 (7), although it has an expansive action, thus needing the propelling spring ring element for such—pictures 36, 37 and 38. This referred element is a ring reduced in its thickness, which body might have a positive (picture 36) or even negative torsional shape (picture 37), as well as none of these attributes, but a plat shape (picture 38) with slightly undulating slopes in order to work as a propelling spring.
b) Concerning to performance and all other aspects, it worth the same technical considerations already exposed into words and pictures 23 and 24 concerning to the AVCE1.

The Sealing Ring in Built-in Grooves—AVCE4

In pictures 39 and 40 is shown the first AVCE4 element, the sealing ring, with expansive action, rectangular shaped, and a small chamfer—picture 40 (3)—in the top internal side. In picture 41 is depicted the second AVCE4 element, the built-in groove (4) in the piston (6), plus the propelling spring ring element (11). As one can see, its groove has contours to perfectly settlement the sealing ring—picture 42 (1). Once the sealing ring is settled and assembled, it serves as a seat plate to the conventional ring 42 (7), which is depicted in picture 42 touching the cylinder bore wall (9).

In picture 43 is shown the AVCE4 in double composition; the bottom (1) and the top (1), with their lower (11) and top (11) propelling spring rings elements, exercising a constant propulsive force (14) in order to help the sealing rings (1) press the conventional ring (7), which scrapes the cylinder bore wall (9).

Technical considerations about AVCE4:
a) As well as AVCE3, the AVCE4 depends on the propelling force of the propelling spring ring element—in picture 43 (11)—in order to do its sealing work with the conventional ring 43 (7).
b) Concerning to the performance and all other technical aspects, it is applied the same technical considerations related to AVCE1, exposed into words and in pictures 23 and 24.

The Sealing Ring in Built-in Grooves—AVCE5

In pictures 44 and 45 is depicted the first AVCE5 element, the sealing ring. It has a constrictive (12) and propulsive action, differently from its predecessors; also has a multi-angled shape (picture 44) with two inclined and trapezoidal shaped faces 45 (2), with perfectly parallel slopes that could vary in angle but not among them.

Picture 46 illustrates the second AVCE5 element, depicted as a great built-in groove in the piston (6). In perspective is depicted the built-in groove in the lower part indentified by (4), and in the top the built-in groove identified by (4). In the middle, in perspective, is the conventional ring's groove (5).

Picture 47 presents the AVCE5 (1) placed in its groove (4), in a ascending movement piston (6), with the conventional ring (7) leaned in the bottom of its groove (5).

Technical considerations about ACVE5:
a) By having a multi-angled shape 45 (2) and constrictive action 48 (12), when it is placed in its groove with compatible slopes 48 (4), the AVCE5 slides, thus creating a propulsive force 48 (14) towards the ring 48 (7) and sealing the gas leak (blow by) in spaces 48 (13) among its groove 48 (4) and the conventional ring 48 (7).
b) In picture 48 is depicted AVCE5 in double composition: in the bottom (1) and top (1); with the piston (6) in downwards movement, one can notice that the top ring element (1) went up, pushed by the conventional ring (7), completely flat against the back of its groove (4). The inferior ring element (1), on the other hand, rose due to its propulsive force (14), thus pressing the conventional ring (7).
c) Picture 49 shows AVCE5 in double composition, with its elements touching the conventional ring (7). The conventional ring, on the other hand, is at its intermediate position; in other words, when the piston (6) is going downwards. Both AVCE5, indicated by (1), are slightly away from the back of their grooves, and united to the conventional ring (7), thus completely sealing any leak spaces or rooms.
d) Concerning to performance and other technical aspects, all the same technical considerations regarding to the AVCE1 already exposed into words and in pictures 23 and 24 are valid.

The Sealing Ring in Built-in Grooves—AVCE6

In picture 50 is shown the first AVCE6 element, the sealing ring. It has expansive and propulsive action, with two sloping faces of trapezoidal aspect 51 (2), two perfectly parallel faces that could vary in angle, but remaining parallel among them.

Picture 52 illustrates the second AVCE6 element, seen as a great built-in groove embedded in the piston (6); in perspective one can see the built-in groove in the bottom (4) as well as in the top (4), and, in the middle—also in perspective—is the groove (5) of the conventional ring (7).

Picture 53 depicts the AVCE6 in double position, lower (4) and top (4) with the piston (6) in upwards movement. One can see that the top ring element (1) went down, pressing the conventional ring (7) while the lower ring element (1) went down pushed by the conventional ring (7).

Technical considerations about AVCE6:
a) Because of its multi-angular shape—picture 51—with parallel slopes among them—picture 51 (2)—when it is placed in its groove with compatible inclinations 53 (8) the AVCE6 is driven to slide due to its expansive force (15). This movement generates a propulsive force towards the conventional ring (7), thus sealing gas and oil leak.
b) Regarding to the performance and all other technical aspects, the same considerations about AVCE1 already exposed in words and in pictures 23, 24 and 25 are valid.

### Numerical relation of the details

1—Sealing Ring Element

2—Trapezoidal Inclination

3—Chamfer

4—Built-in Groove

5—Conventional Groove

6—Piston

7—Conventional Ring

8—Compatible Slope of Built-in Groove

9—Cylinder Bore Wall

10—Salience/Projection

11—Propelling Spring Ring Element

12—Constrictive Action

13—External Space between Built-in Groove and Conventional Ring

14—Propulsive Action

15—Expansive Action

16—Simple Ring or Composed Ring (Lower Part)

17—Composed Ring (Top Part)

18—L-Shape/Corner Shape

19—Indent

20—Bounce

21—Fitting End

22—Ring Debasement Edge

23—Groove Placed in the External Face of the Ring

1. COMPENSATIVE AND SEALING RINGS FOR PISTONS OF ENGINES, COMPRESSORS, EXAUSTORS AND PUMPS, placed in conventional grooves or unified to them. The Compensative Rings are presented in 4 models and the Sealing Rings are presented in 6 different models. Characterized by fittings and indents between tips that insert and mate to other ring models, and by lodging into conventional grooves or built-in grooves unified to the conventional. They have expansive 29 (15), constrictive 47 (12) and propulsive 43 (14) action, that leads to seal the room and space 48 (13) between the groove 48 (4) and the conventional ring 48 (7); they have a self-propulsive force, or are pushed by a propulsive spring ring—pictures 36, 37 and 38.

2. The Ring AC1 (picture 1) according to claim 1, characterized by being a composed ring, whose bottom part—picture 2 (16)—has an external indent 2 (19) on the ring tips, compatible to fit the external projection 2 (10) in the top ring 2 (17), with the possibility of insertion among the ring set and the Propelling Spring Ring Element—pictures 36, 37 and 38.

3. The Ring AC2 (picture 6) according to claim 1, characterized by being a composed ring (picture 7), whose bottom 7 (16) has an internal indent 7 (19) on the inside of the ring's tips, with measures compatible to fit the internal salience 7 (10) existing on the top ring 7 (17), with the possibility of insertion among the ring set and the Propelling Spring Ring Element—pictures 36, 37 and 38.

4. The Ring AC3 (picture 11) according to claim 1, characterized by being a composed ring (picture 11), with two identical parts (picture 12) with indents on the external tips 12 (19), and saliencies or bosses on the external edges—as seen on picture 12 (10), with the possibility of insertion among the ring set and the Propelling Spring Ring Element—pictures 36, 37 and 38.

5. The Ring AC4 (picture 14) according to claim 1, characterized by being a composed ring (picture 14), with two identical parts—as seen in picture 15 (19)—with internal indents on tips and saliencies or bosses on the internal edges 15 (10), having or not a debasement, extended until 180° on the external edge—picture 16 (22) and 17 (22)—or groove extended until 180° on the external face of the ring—pictures 18 (23) and 19 (23), with the possibility of insertion among the ring set and the Propelling Spring Ring Element—pictures 36, 37 and 38.

6. The Ring AVCE1, according to claim 1, characterized by having a rectangular and trapezoidal shape, as seen in picture 20 (2), with or without chamfer—picture 20 (3)—with expansive 24 (15) and propulsive 24 (14) action.

7. The Ring AVCE2 picture 27, according to claim 1, characterized by presenting a rectangular and trapezoidal shape (2), with salience (10), with or without chamfer (3) and expansive 31 (15) and propulsive 31 (14) action.

8. The Ring AVCE3 picture 33, according to claim 1, characterized by presenting a rectangular shape, with a small salience (10), with or without chamfer (3), with expansive action 35 (15) and a propulsion effect 35 (14) due to the propelling spring ring—pictures 36, 37 and 38.

9. The Ring AVCE4 picture 40, according to claim 1, characterized by presenting a rectangular shape, with or without chamfer (3), with expansive action 43 (15) and with propulsive effect 43 (14) due to the propelling spring ring—pictures 36, 37 and 38.

10. Propelling Spring Ring Element, according to claim 1, characterized by presenting a positive (picture 36) or negative (picture 37) torsional body, or even with no torsional effect, but with flat shape, having a slight wavy warp (picture 38), placing on the bottom of the AVCE3—picture 35 (11)—and AVCE4—picture 42 (11)—built-in grooves.

11. The Ring AVCE5 picture 44, according to claim 1, characterized by presenting a constrictive 48 (12) and propulsive 48 (14) action, with multi-angular shape (picture 44) and two prone faces of trapezoidal aspect on its sectional cut as seen in picture 45 (2), with parallel inclinations exactly equal among them, whose could vary in angle, but never among them.

12. The Ring AVCE6 picture 50, according to claim 1, characterized by presenting expansive (15) and propulsive (14) action, with multi-angular shape—picture 51—and two trapezoidal faces 51 (2) on its sectional cut, with exactly equal parallel inclinations that could vary in angle, but never among them.

13. According to claim 1, the use of AVCEs (picture 26) presupposes their accommodation in so called BUILT-IN GROOVES unified to the conventional groove 26 (5) of the piston, characterized by internal cavities to the piston body—picture 26 (4)—adjacent to the top 26 (4), the bottom 26 (4) or both sides (picture 26) of the conventional groove 26 (5), with trapezoidal shape 26 (4), rectangular 34 (4) or multi-angular shape 46 (4), whose walls or faces should be made of steel or equally resistant material.
